(19) United States
(12) Patent Application Publication
(10) Pub. No.: US 2015/0054855 A1
(43) Pub. Date: Feb. 26, 2015

(54) IMAGE PROCESSING APPARATUS, IMAGE PROCESSING SYSTEM, IMAGE PROCESSING METHOD, AND PROGRAM

(71) Applicant: CANON KABUSHIKI KAISHA, Tokyo (JP)

(72) Inventors: Kazuyuki Sato, Yokohama-shi (JP); Minoru Kusakabe, Yokohama-shi (JP); Takuya Tsujimoto, Kawasaki-shi (JP)

(21) Appl. No.: 14/372,331

(22) PCT Filed: Jan. 22, 2013
(86) PCT No.: PCT/JP2013/000292

§ 371 Date: Jul. 15, 2014

(30) Foreign Application Priority Data
Jan. 30, 2012 (JP) 2012-016512
Nov. 30, 2012 (JP) 2012-262391

(51) Int. Cl. G09G 5/373; G06T 3/40; G06F 3/0484

(52) U.S. Cl. CPC G09G 5/373; G06F 3/04845; G06T 3/40; G06T 2200/24; G09G 2340/045
USPC 345/661

(57) ABSTRACT

An image processing apparatus according to the present invention comprises a modification unit that modifies image data displayed on a display apparatus on the basis of a user operation. For example, when a user performs a zoom-in operation in a condition where second image data for displaying a full image of a slide glass on which a sample is provided are displayed, the modification unit displays first image data for displaying a full image of the sample. When the user performs a zoom-out operation in a condition where the first image data are displayed, the modification unit displays the second image data.

### TECHNICAL FIELD

The present invention relates to an image processing apparatus, an image processing system, an image processing method, and a program.

### BACKGROUND ART

In a conventional method, to enable recognition of the size of a sample provided on a slide glass, an image (a full image or a partial image) of the sample and a full image of the slide glass on which the sample is provided (more specifically, a full image of a slide) are displayed simultaneously.

Patent Literature 1, for example, discloses a method of displaying a partial image of a sample and a full image of a slide side by side. Further, in the technique disclosed in Parent Literature 1, the partial image of the sample is also displayed in reduced form on the full image of the slide so that an observation position (a region) of the sample can be recognized.

When the image of the sample and the full image of the slide are displayed side by side, however, a larger display region (a region in which the image is displayed within a region of a screen) is required in comparison with a case where only the image of the sample is displayed. Further, when the image of the sample and the full image of the slide are displayed side by side, the display region of the image of the sample must be reduced in comparison with a case where only the image of the sample is displayed.

Meanwhile, a method of superimposing the full image of the slide (the slide image) onto the image of the sample (the sample image) for display has been considered.

In this case, however, all or a part of the sample image may be hidden by the slide image, making observation of the hidden location impossible. To check the hidden region of the sample image, the slide image must either be moved or removed from display. Hence, it is sometimes difficult to perform an operation to observe the sample image efficiently.

Further, an operation to move the slide image and an operation to switch between display and non-display of the slide image are similar to main operations (an operation to move an observation position and an operation to modify an observation magnification) performed during observation of the sample image but must be added anew, and therefore an increase in operational complexity occurs.

### CITATION LIST

### Patent Literature

[PTL 1]

Japanese Patent Application Publication No. 2001-166218

### SUMMARY OF INVENTION

### Technical Problem

An object of the present invention is to provide a technique with which an image displayed on a display apparatus can be modified efficiently by a simple operation so that a sample can be observed and diagnosed efficiently from the image.

### Solution to Problem

The present invention in its first aspect provides an image processing apparatus capable of displaying, on a display apparatus, first image data for displaying a full image of a sample and second image data for displaying a full image of a slide glass on which the sample is provided,

the image processing apparatus comprising a modification unit that modifies the image data displayed on the display apparatus on the basis of a user operation,

wherein, when a user performs a zoom-out operation to reduce a displayed image in a condition where the first image data are displayed on the display apparatus, the modification unit displays the second image data on the display apparatus.

The present invention in its second aspect provides an image processing apparatus capable of displaying, on a display apparatus, first image data for displaying a full image of a sample and second image data for displaying a full image of a slide glass on which the sample is provided,

the image processing apparatus comprising a modification unit that modifies the image data displayed on the display apparatus on the basis of a user operation,

wherein, when a user performs a zoom-in operation to enlarge a displayed image in a condition where the second image data are displayed on the display apparatus, the modification unit displays the first image data on the display apparatus.

The present invention in its third aspect provides an image processing apparatus capable of displaying, on a display apparatus, fifth image data for displaying a full image of a plurality of slides and sixth image data for displaying a partial image of a gross sample,

the image processing apparatus comprising a modification unit that modifies the image data displayed on the display apparatus on the basis of a user operation,

wherein a part of the gross sample is provided on each of the slides as a sample, and

when a uses performs a zoom-out operation to reduce a displayed image in a condition where the fifth image data are displayed on the display apparatus, the modification unit displays the sixth image data on the display apparatus.

The present invention in its fourth aspect provides an image processing apparatus capable of displaying, on a display apparatus, fifth image data for displaying a full image of a plurality of slides and sixth image data for displaying a partial image of a gross sample,

the image processing apparatus comprising a modification unit that modifies the image data displayed on the display apparatus on the basis of a user operation,

wherein a part of the gross sample is provided on each of the slides as a sample, and

when a user performs a zoom-in operation to enlarge a displayed image in a condition where the sixth image data are displayed on the display apparatus, the modification unit displays the fifth image data on the display apparatus.

The present invention in its fifth aspect provides an image processing apparatus capable of displaying, on a display apparatus, fourth image data for displaying a partial image of a sample and seventh image data for displaying a partial image of the sample obtained by a different imaging apparatus from the fourth image data,

the image processing apparatus comprising a modification unit that modifies the image data displayed on the display apparatus on the basis of a user operation,

wherein, when a user performs a zoom-in operation to enlarge a displayed image in a condition where the fourth image data are displayed on the display apparatus, the modification unit displays the seventh image data on the display apparatus.

The present invention in its sixth aspect provides an image processing apparatus capable of displaying, on a display apparatus, fourth image data for displaying a partial image of a sample and seventh image data for displaying a partial image of the sample obtained by a different imaging apparatus from the fourth image data,

the image processing apparatus comprising a modification unit that modifies the image data displayed on the display apparatus on the basis of a user operation,

wherein, when a user performs a zoom-out operation to reduce a displayed image in a condition where the seventh image data are displayed on the display apparatus, the modification unit displays the fourth image data on the display apparatus.

The present invention in its seventh aspect provides an image processing method in which first image data for displaying a full image of a sample and second image data for displaying a full image of a slide glass on which the sample is provided can be displayed on a display apparatus,

the image processing method comprising a modification step in which a computer modifies the image data displayed on the display apparatus on the basis of a user operation,

wherein the modification step includes a step in which when a user performs a zoom-out operation to reduce a displayed image in a condition where the first image data are displayed on the display apparatus, the computer displays the second image data on the display apparatus.

The present invention in its eighth aspect provides an image processing method in which first image data for displaying a full image of a sample and second image data for displaying a full image of a slide glass on which the sample is provided can be displayed on a display apparatus,

the image processing method comprising a modification step in which a computer modifies the image data displayed on the display apparatus on the basis of a user operation,

wherein the modification step includes a step in which, when a user performs a zoom-in operation to enlarge a displayed image in a condition where the second image data are displayed on the display apparatus, the computer displays the first image data on the display apparatus,

The present invention in its ninth aspect provides an image processing method in which fifth image data for displaying a full image of a plurality of slides and sixth image data for displaying a partial image of a gross sample can be displayed on a display apparatus,

the image processing method comprising a modification step in which a computer modifies the image data displayed on the display apparatus on the basis of a user operation,

wherein a part of the gross sample is provided on each of the slides as a sample, and

the modification step includes a step in which, when a user performs a zoom-out operation to reduce a displayed image in a condition where the fifth image data are displayed on the display apparatus, the computer displays the sixth image data on the display apparatus.

The present invention in its tenth aspect provides an image processing method in which fifth image data for displaying a full image of a plurality of slides and sixth image data for displaying a partial image of a gross sample can be displayed on a display apparatus,

the image processing method comprising a modification step in which a computer modifies the image data displayed on the display apparatus on the basis of a user operation,

wherein a part of the gross sample is provided on each of the slides as a sample, and

the modification step includes a step in which, when a user performs a zoom-in operation to enlarge a displayed image in a condition where the sixth image data are displayed on the display apparatus, the computer displays the fifth image data on the display apparatus.

The present invention in its eleventh aspect provides an image processing method in which fourth image data for displaying a partial image of a sample and seventh image data for displaying a partial image of the sample obtained by a different imaging apparatus from the fourth image data can be displayed on a display apparatus,

the image processing method comprising a modification step in which a computer modifies the image data displayed on the display apparatus on the basis of a user operation,

wherein the modification step includes a step in which, when a user performs a zoom-in operation to enlarge a displayed image in a condition where the fourth image data are displayed on the display apparatus, the computer displays the seventh image data on the display apparatus.

The present invention in its twelfth aspect provides an image processing method in which fourth image data for displaying a partial image of a sample and seventh image data for displaying a partial image of the sample obtained by a different imaging apparatus from the fourth image data can be displayed on a display apparatus,

the image processing method comprising a modification step in which a computer modifies the image data displayed on the display apparatus on the basis of a user operation,

wherein the modification step includes a step in which, when a user performs a zoom-out operation to reduce a displayed image in a condition where the seventh image data are displayed on the display apparatus, the computer displays the fourth image data on the display apparatus.

The present invention in its thirteenth aspect provides a program for causing a computer to execute each step of the above image processing method according to the present invention.

The present invention in its fourteenth aspect provides an image processing system comprising:

an image processing apparatus; and

a display apparatus for displaying image data output from the image processing apparatus,

wherein the image processing apparatus is the above image processing apparatus according to the present invention.

According to the present invention, an image displayed on a display apparatus can be modified efficiently by a simple operation, and therefore a sample can be observed and diagnosed efficiently from the image.

Further features of the present invention will become apparent from the following description of exemplary embodiments with reference to the attached drawings.

### BRIEF DESCRIPTION OF DRAWINGS

FIG. 1 shows an example of a configuration of an image processing system according to a first embodiment.

FIG. 2 shows an example of an internal configuration of an image processing apparatus according to the first embodiment.

FIGS. 3A to 3F show display examples of a slide, a gross sample, and image data according to the first embodiment.

FIG. 4 shows an example of a functional configuration of the image processing apparatus according to the first embodiment.

FIG. 5 shows an example of a flow of processing executed by the image processing apparatus according to the first embodiment.

FIG. 6 shows an example of display enlargement processing according to the first embodiment.

FIG. 7 shows an example of display reduction processing according to the first embodiment.

FIGS. 8A to 8E show examples of rendering data switching according to the first embodiment.

FIG. 9 shows an example of rendering data generation processing according to a second embodiment.

FIG. 10 shows a display example of image data according to the second embodiment.

FIG. 11 shows an example of rendering data generation processing according so a third embodiment.

FIGS. 12A and 12B show display examples of image data according to the third embodiment.

FIGS. 13A and 13B show display examples of image data according to the third embodiment.

FIG. 14 shows an example of rendering data switching according to a fourth embodiment.

FIGS. 15A and 15B show examples of an image selection cursor display and an operating device according to the fourth embodiment.

### DESCRIPTION OF EMBODIMENTS

### First Embodiment

A first embodiment of the present invention will be described below using the drawings.

The present invention controls switching of displayed image data in response to operations such as a zoom-in (enlargement) operation for enlarging the displayed image and a zoom-out (reduction) operation for reducing the displayed image.

The image data according to this embodiment are captured (generated) by an imaging apparatus such as a microscope apparatus capable of capturing high resolution image data, for example.

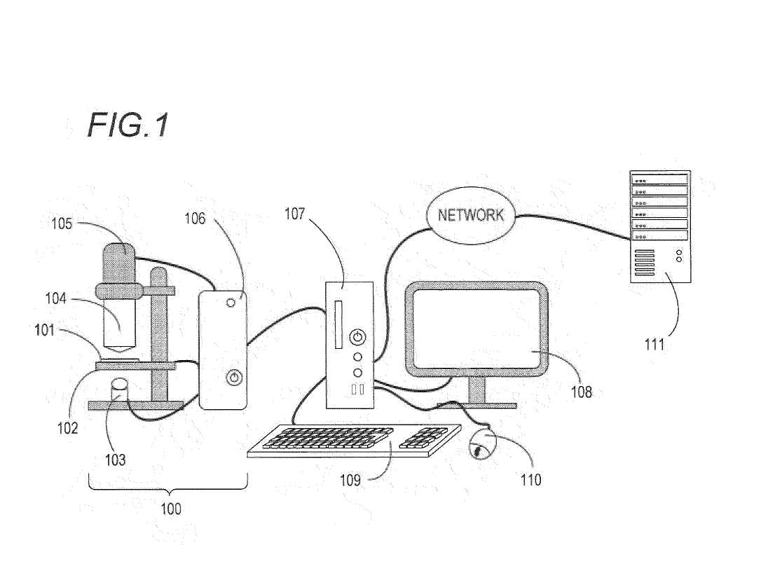

FIG. 1 shows an example of a configuration of an image processing system according to this embodiment.

In FIG. 1, a reference numeral 100 denotes a microscope apparatus that captures two-dimensional images.

A reference numeral 101 denotes a slide carrying a sample that serves as an object to be captured. In this embodiment, the sample is assumed to be an object through which light passes (a transmissive object).

A reference numeral 102 denotes a stage for carrying the slide 101. The stage 102 can be moved within a perpendicular plane to an optical axis direction of light emitted from a light source 103. The stage 102 can also be moved in the optical axis direction. By moving the stage 102 in the optical axis direction, a focal position in a thickness direction of the sample can be modified.

The reference numeral 103 denotes the light source, and a reference numeral 104 denotes an objective lens. The light source 103 emits light that passes through the slide 101 so as to enter the objective lens 104.

A reference numeral 105 denotes an imaging unit. The imaging unit 105 generates image data from the light obtained through the objective lens 104.

A reference numeral 106 denotes a controller. The controller 106 performs operation control on the stage 102, the light source 103, the imaging unit 105, and so on.

Note that the objective lens 104 may be configured such that a magnification (an object enlargement ratio) thereof can be modified continuously or in steps. In this case, the controller 106 is preferably made capable of controlling the magnification.

In this embodiment, the sample is assumed to be a transmissive object, but the sample does not have to be a transmissive object.

A reference numeral 107 denotes an image processing apparatus according to this embodiment. The image processing apparatus 107 transmits an operation instruction to the microscope apparatus 100 and receives the image data from the microscope apparatus 100.

The image processing apparatus 107 is also capable of receiving image data from an apparatus other than the microscope apparatus 100.

For example, the image processing apparatus 107 may receive image data captured by an imaging apparatus such as a digital camera, an X-ray camera, a CT (computed tomography) scanner, an MRI (magnetic resonance imaging) scanner, a PET (positron emission tomography) scanner, an electron microscope, a mass microscope, a scanning probe microscope, an ultrasound microscope, a fundus camera, an endoscope, or a scanner, none of which are shown in the drawings.

For example, an image of an origin (a gross sample; in a case where the sample is cut from a certain organ, all or a part or the organ) of the sample is captured by the imaging apparatus not shown in the drawings.

The image processing apparatus 107 stores the received image data in a server 111.

The image processing apparatus 107 then obtains the image data from the server 111 in response to a user operation, generates rendering data, and outputs the rendering data to a display apparatus 108.

Nose that the image data may be transferred using a cable capable of transferring data, such as a USB cable, or wirelessly.

The reference numeral 108 denotes the display apparatus, which displays the rendering data output from the image processing apparatus 107. Note that the rendering data are nor limited to image data captured by an imaging apparatus, and may be image data for displaying a screen that prompts the user to operate the microscope apparatus 100, for example. The image data may also be image data displaying patient information and image data promoting input of a diagnosis result.

A reference numeral 109 denotes a keyboard used by the user to input operation instructions.

A reference numeral 110 denotes a mouse used by the user to input operation instructions.

The reference numeral 111 denotes the server, which is connected to the image processing apparatus 107 via a network and stores the image data captured by the microscope apparatus 100 and so on. Note that in this embodiment, the image processing apparatus 107 is configured to record the received image data in the server 111, but the image data captured by the imaging apparatus may be recorded in the server 111 directly.

The display apparatus 108 and the image processing apparatus 107 may be formed integrally or separately. The display apparatus 108 and the microscope apparatus 100 may also be formed integrally or separately. Buttons or the like used by the user to input operation instructions may be provided on the display apparatus 108. Further, a part of the functions of the image processing apparatus 107 (for example, a display mode switching control unit 402 and a rendering data generation unit 403 to be described below) may be provided in the display apparatus 108.

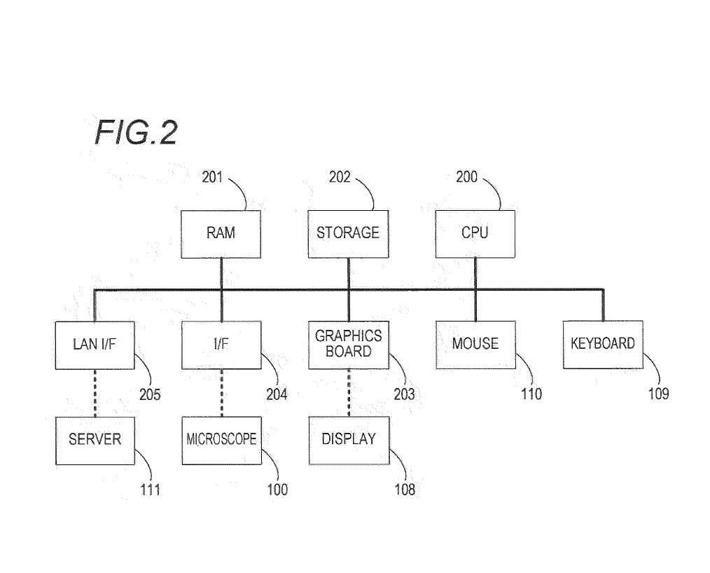

FIG. 2 shows an example of an internal configuration of the image processing apparatus 107 and a connection relationship to an external device.

A CPU 200 accesses a RAM 201 or the like as needed, and performs calculations required for various processing.

The RAM 201 is used as a working area or the like of the CPU 200, and temporarily stores data required by programs and processing currently underway.

A storage apparatus 202 serves as an auxiliary storage apparatus that stores programs executed by the CPU 200, image data, and so on fixedly. A magnetic disk drive such as an HDD or a semiconductor device (an SSD or the like) using a Flash memory may be employed as the storage apparatus 202.

A graphics board 203 is used to output the rendering data to the outside (the display apparatus 108).

A dedicated interface 204 is an interface for connecting the image processing apparatus 107 communicably to the external device (the microscope apparatus 100).

A LAN interface 205 is an interface for connecting the image processing apparatus 107 communicably to the server 111.

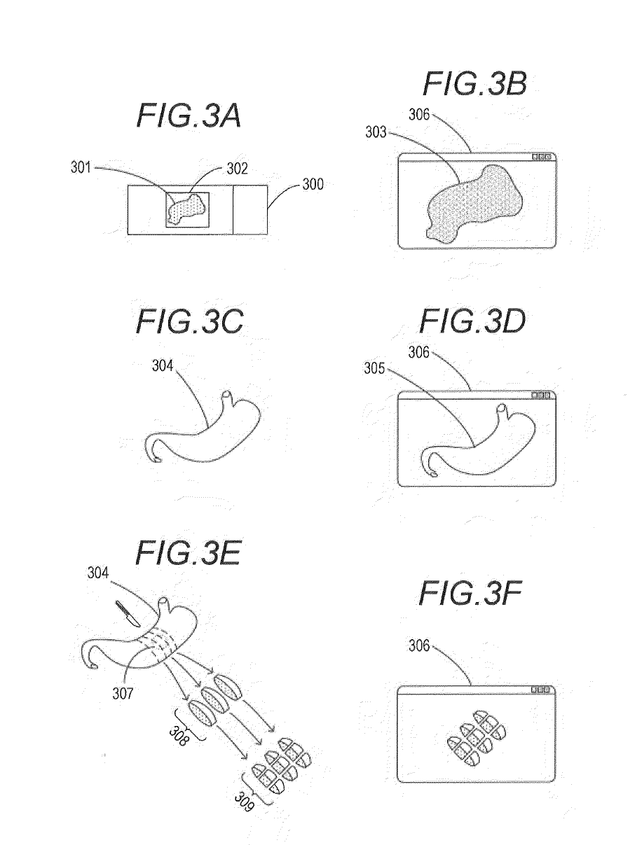

FIGS. 3A to 3F are views showing display examples of the slide 101, the gross sample (the origin of the sample), and the image data.

FIG. 3A shows an example of the configuration of the slide 101. The slide 101 is created by covering and fixing a sample 301 provided on a slide glass 300 with a cover glass 302 and a sealant. The sample 301 is constituted by, for example, tissue, cells, liquid, or the like excreted or extracted from a human body. Image data obtained by capturing an image of the entire slide glass (the entire slide) on which the sample is provided will be referred to as slide image data.

FIG. 3B is a view showing a display example of image data obtained by capturing an image of the sample 301. In the example of FIG. 3B, a full image 303 of the sample 301 is displayed in a window 306. Image data obtained by capturing an image of the entire sample (only the part of the sample on the slide) will be referred to as sample image data.

FIG. 3C shows an organ (a gross sample 304) serving as a source from which the sample 301 was cut or extracted.

FIG. 3D is a view showing a display example of image data obtained by capturing an image of the gross sample 304. In the example of FIG. 3D, a full image 305 of the gross sample 304 is displayed in the window 306. Image data obtained by capturing an image of the entire gross sample will be referred so as gross image data. In the display example of FIG. 3D, a full image of the gross sample 304 is displayed, but one or more parts of the gross sample, to be described below, may be displayed instead. Further, when a part of the gross sample is displayed, the part is preferably displayed such that a correspondence relationship to the gross sample 304 serving as the cutting source and the sample 301 is evident.

FIG. 3E is a view showing an example of a process for extracting the sample 301 from the gross sample 304. A reference numeral 307 denotes a site of a suspected pathological abnormality in the gross sample (the corresponding organ). In the example of FIG. 3E, the gross sample 304 is fixed by formalin or the like to facilitate cutting, whereupon three pieces centering on the site 307 of the suspected pathological abnormality are cut out, as shown by a reference numeral 308. Further, in this example, the three pieces are cut into a total of nine pieces, as shown by a reference numeral 309, so that a size of the pathological abnormality and a degree of spread to the periphery of the pathological abnormality can be checked in detail using a microscope. The reference numerals 308 and 309 will be referred to as parts of the gross sample. The parts 309 of the gross sample are embedded in paraffin (wax) or the like to facilitate sectioning thereof. A block in which a part of the gross sample is embedded in paraffin or the like is known as a paraffin block. The sample 301 is created by sectioning a part of the paraffin block using a tool known as a microtome, not shown in the drawings.

FIG. 3F is a view showing a display example of image data obtained by capturing an image of the parts 309 of the gross sample. In the example of FIG. 3F, the parts 309 of the gross sample are displayed in the window 306. The image data obtained by capturing an image or the parts 309 of the gross sample will be referred to as gross partial image data. In this example, the gross partial image data correspond to the parts 309 of the gross sample, but are not limited thereto.

Observing the sample 301 excreted or extracted from the human body under a microscope or the like and diagnosing the presence of a pathological abnormality and the type of the pathological abnormality using pathological knowledge or a method is generally known as pathological diagnosis.

Images obtained by X-ray camera, a CT scanner, an MRI scanners a PET scanner, a fundus camera, an endoscope, a scanner, or the like and images of the origin (the gross sample) of the sample or the like are called clinical images. Note that when a clinical image serving as clinical information and an image of the slide carrying the sample are absent, it is difficult to grasp the size, degree of advancement, and so on of a pathological abnormality such as a tumor or a carcinoma from a sample image (a pathological image) serving as pathological information alone, and it may therefore be impossible to reach a final diagnosis. Hence, information relating to the size of the sample, such as the size and so on of the gross sample (the origin of the sample), is important for observing the sample during pathological diagnosis. When a full image of the sample is displayed without displaying a comparison to the sample, a scale, or the like, as shown in FIG. 3B, it is difficult to grasp the size of the sample. The size of the sample may be grasped by, for example, observing the slide directly to grasp the relative size of the sample relative to the slide glass. In this embodiment, the slide image data are displayed to enable the user to grasp the size of the sample.

Further, three-dimensional structural information indicating a positional relationship between the sample and the gross sample and so on, such as information indicating what the origin of the sample (the gross sample) is and an overall condition of the origin of the sample (whether or not the sample was cut from an appropriate position of the gross sample) is extremely important for observing the sample correctly to grasp the size and degree of advancement of a pathological abnormality such as a tumor or a carcinoma, determining whether or not the site of the pathological abnormality has been completely removed by an operation, making a correct diagnosis, and so on. In this embodiment, the gross image data are displayed to enable the user to grasp this information.

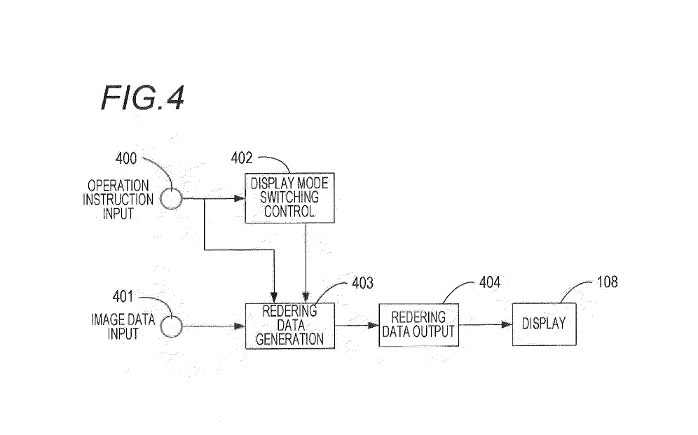

FIG. 4 is a block diagram showing an example of a functional configuration of the image processing apparatus 107.

Respective function blocks to be described below are realized by having the CPU 200 execute a program, for example.

The image processing apparatus 107 according to this embodiment is capable of displaying a full image of the sample, a partial image of the sample, a full image of the slide, and a full image of the gross sample selectively on the display apparatus 108.

An operation instruction input terminal 400 is a terminal into which an operation instruction is input in response to a user operation. For example, when the user performs an image zoom-in operation, an image zoom-out operation, an operation to modify a displayed position of an image, and so on using one keyboard 109, the mouse 110, or the like, an instruction corresponding to the performed operation is input into the operation instruction input terminal 400.

An image data input terminal 401 is a terminal into which the image data are input. The image data include the sample image data, slide image data, and gross image data described above. Information indicating imaging conditions during imaging is attached to the respective image data. The imaging condition information includes, for example, a lens magnification, a pixel pitch of an imaging device (an image sensor), and so on.

The display mode switching control unit 402 and the rendering data generation unit 403 switch the image data displayed on the display apparatus 108 on the basis of a user operation.

More specifically, the display mode switching control unit 402 controls a display mode on the basis of an input operation instruction. The display modes include a sample image display mode, a slide image display mode, and a gross image display mode. In this embodiment, all or a part of the sample image data are displayed when the sample image display mode is set as the display mode. In the slide image display mode, the slide image data are displayed. In the gross image display mode, the gross image data are displayed. The rendering data generation unit 403 generates image data (rendering data) to be displayed by the display apparatus 108 from the input image data on the basis of an input operation instruction and a control signal (a signal indicating the display mode) output from the display mode switching control unit 402.

A rendering data output unit 404 outputs the rendering data generated by the rendering data generation unit 403 to the display apparatus 108.

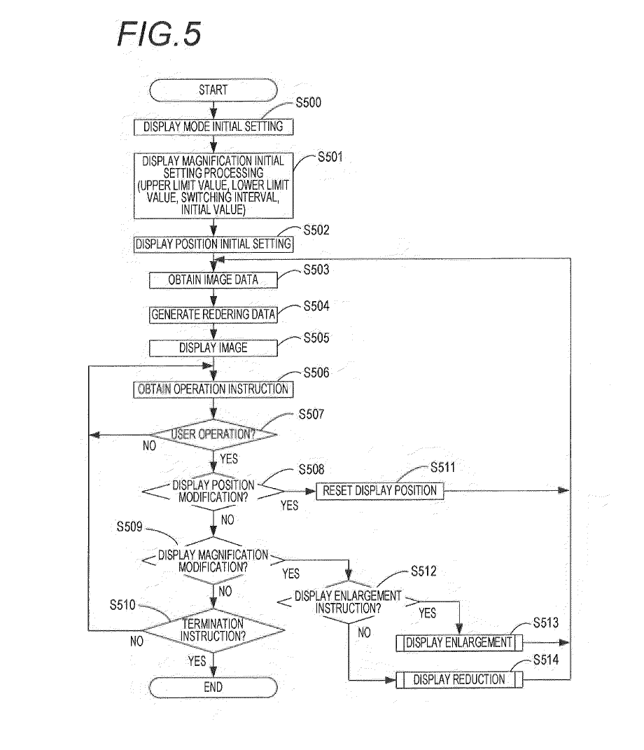

FIG. 5 is a flowchart showing a flow of processing (display switching processing for switching the displayed image data) executed by the image processing apparatus 107. This processing flow starts when, for example, a power supply of the image processing apparatus 107 is introduced, an application for displaying captured image data is activated, or the like.

First, in Step S500, the display mode switching control unit 402 performs initial setting of the display mode. In this embodiment, the sample image display mode is set as an initial value (the initial mode), but the slide image display mode or the gross image display mode may be set as the initial mode. Further, in this step, the display mode switching control unit 402 sets an initial value of an acquisition range of the sample image data. In this embodiment, an entire region of the sample is set as the initial value of the acquisition range, but a partial region of the sample may be set as the initial value of the acquisition range. The acquisition range is modified while modifying a display magnification and a display position, as will be described below, so that a size thereof equals or exceeds a size of a region in which the sample is to be displayed, for example.

Next, in Step S501, the display mode switching control unit 402 performs initial setting of the display magnification (an enlargement ratio) of the sample image data. In this step, for example, an initial value, a maximum value (an upper limit value), a minimum value (a lower limit value), a switching interval, and so on of the display magnification are set. Note that the switching interval of the display magnification may be, but need not be, an equal interval. For example, the switching interval of the display magnification may be set at typical magnifications of an objective lens of a microscope, i.e. 4 times, 10 times, 20 times, and 40 times.

In Step S502, the display mode switching control unit 402 performs initial setting of the display position (a position of the sample to be displayed in a reference position of the screen) of the sample image data. The reference position may be a central position of the screen (the window) or another position (an origin of the screen (an uppermost left position), for example). An initial value of the display position may be a central position of the sample or another position. Note that this embodiment is configured such that only the display position of the sample image data can be modified, but the display position of data other than the sample image data may also be made modifiable.

The various initial values set in Steps S500 to S502 may take values input by the user, values calculated automatically by the image processing apparatus 107, values prepared in advance, and so on.

Next, in Step S503, the rendering data generation unit 403 obtains image data from the server 111 on the basis of the set display mode and acquisition range. More specifically, when the display mode is the sample image display mode, data within the set acquisition range are obtained from the sample image data. In the slide image display mode, the slide image data are obtained, and in the gross image display mode, the gross image data are obtained.

In Step S504, the rendering data generation unit 403 generates the rendering data from the image data obtained in Step S503. For example, when all or a part of the sample image data are obtained, the rendering data are generated by implementing enlargement processing or reduction processing on the obtained image data on the basis of information such as the set display magnification and display position and the imaging conditions attached to the image data. When the slide image data or the gross image data are obtained, the obtained image data are set as the rendering data.

Next, in Step S505, the rendering data output unit 404 outputs the rendering data generated in step S504 to the display apparatus 108. As a result, the rendering data are displayed.

Next, in Step S506, the display mode switching control unit 402 receives an input operation instruction.

Next, in Step S507, the display mode switching control unit 402 determines whether or not an operation instruction has been input (whether or not a user operation has been performed). When an operation instruction has been input, the processing is advanced to Step S508, and when an operation instruction has not been input, the processing is returned to Step S506.

Operation instructions include, for example, a display magnification modification instruction input in response to a user operation (a zoom-in operation or a zoom-out operation) to modify the display magnification, a display position modification instruction input in response to a user operation to modify the display position, a termination instruction input in response to a user operation to quit image display, and so on.

The display position modification instruction is input when an operation (a dragging operation) is performed to move a mouse cursor onto the displayed image (sample image, slide image, or gross image) and shift the position of the mouse cursor while holding down a mouse button, for example.

The display magnification modification instruction is input when an operation is performed to rotate a mouse wheel, for example. More specifically, a display reduction (zoom out) instruction is input when a zoom-out operation is performed by rotating the mouse wheel in a rearward direction, and a display enlargement (zoom in) instruction is input when a zoom-in operation is performed by rotating the mouse wheel in a frontward direction.

The termination instruction is input when an operation is performed to select a quit button or a quit menu in the window displaying the sample image, slide image, or gross image, for example.

Note that the user operations described above are not limited to operations of one mouse 110, and the user operations may be performed using the keyboard 109 or another operating device (a touch pad, a trackball, a game controller, or the like, for example). The operation instructions may be input from any of the mouse 110, the keyboard 109, and the other operating devices. The operation instructions may be input from an operating device used for user operations or a device other than an operating device used for user operations.

In Step S508, the display mode switching control unit 402 determines whether or not the operation instruction input in Step S506 is the display position modification instruction.

When the display position modification instruction is determined, processing of Step S511 is performed, whereupon the processing is returned to Step S503. In Step S511, the display mode switching control unit 402 resets the display position in accordance with the display position modification instruction.

When the display position modification instruction is not determined, the processing is advanced to Step S509.

In Step S509, the display mode switching control unit 402 determines whether or not the operation instruction input in Step S506 is the display magnification modification instruction.

When the display magnification modification instruction is determined, the processing is advanced to Step S512.

When the display magnification modification instruction is not determined, the processing is advanced to Step S510.

In Step S512, the display mode switching control unit 402 determines whether or not the operation instruction input in Step S506 is the display enlargement instruction.

When the display enlargement instruction is determined, display enlargement processing is performed in Step S513, whereupon the processing is returned to Step S503.

When the display enlargement instruction is not determined, the display mode switching control unit 402 determines that the display reduction instruction has been input. Accordingly, display reduction processing is performed in Step S514, whereupon the processing is returned to Step S503.

In Step S510, the display node switching control unit 402 determines whether or not the operation instruction input in Step S506 is the termination instruction.

When the termination instruction is determined, predetermined termination processing is performed, whereby the current processing flow is terminated.

When the termination instruction is not determined, processing corresponding to the operation instruction is performed, whereupon the processing is returned to Step S506.

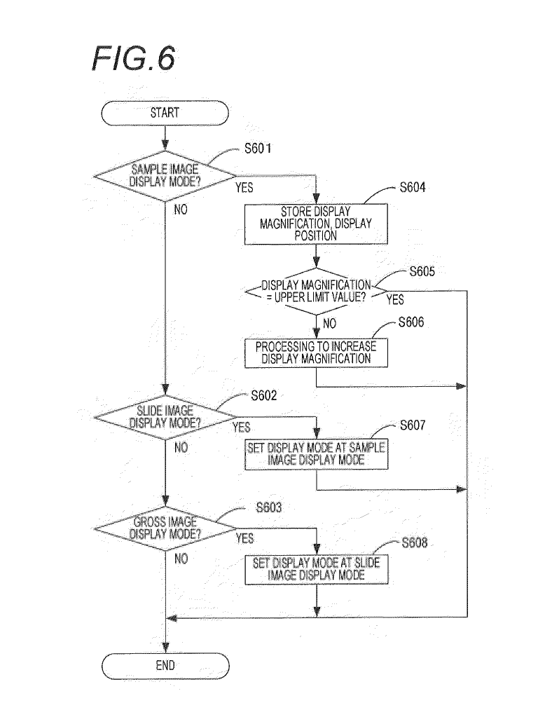

FIG. 6 is a flowchart showing the display enlargement processing of Step S513.

First, in step S601, the display mode switching control unit 402 determines whether or not the currently set display mode is the sample image display mode. When the sample image display mode is determined, the processing is advanced to Step S604, and when the sample image display mode is not determined, the processing is advanced to Step S602.

In Step S604, the display mode switching control unit 402 stores the currently set display magnification and display position.

Next, in Step S605, the display mode switching control unit 402 determines whether or not the currently set display magnification is the upper limit value. When the currently set display magnification is determined to be the upper limit value, the display enlargement processing is terminated (the processing is returned to Step S503). When the currently set display magnification is determined not to be the upper limit value, the processing is advanced to Step S606.

In Step S606, the display mode switching control unit 402 sets the display magnification one step above the currently set display magnification on the basis of the display magnification switching interval set in Step S501, and then terminates the display enlargement processing.

In Step S602, the display mode switching control unit 402 determines whether or not the currently set display mode is the slide image display mode.

When the slide image display mode is determined, processing of Step S607 is performed, whereupon the display enlargement processing is terminated. In Step S607, the display mode switching control unit 402 modifies the display mode setting from the slide image display mode to the sample image display mode. Further, at this time, the display position is set to display the entire sample (the full image of the sample).

When the slide image display mode is not determined, the processing is advanced to Step S603.

In Step S603, the display mode switching control unit 402 determines whether or not the currently set display mode is the gross image display mode.

When the gross image display mode is determined, processing of Step S608 is performed, whereupon the display enlargement processing is terminated. In Step S608, the display mode switching control unit 402 modifies the display mode setting from the gross image display mode to the slide image display mode.

When the gross image display mode is not determined, the display enlargement processing is terminated.

Hence, when the sample image display mode is set, the display enlargement processing is performed to increase the display magnification of the sample image. Further, when another display mode is set, the display mode is modified through the display enlargement processing such that an image enlarged relative to the currently displayed image is displayed.

Therefore, when the user performs the zoom-in operation in a condition where rendering data (first image data) for displaying the full image of the sample are displayed, the rendering data are switched to rendering data (fourth image data) for displaying a partial image of the sample. When the user performs the zoom-in operation in a condition where rendering data (second image data) for displaying the full image of the slide are displayed, the rendering data are switched to the first image data. When the user performs the zoom-in operation in a condition where rendering data (third image data) for displaying the full image of the gross sample are displayed, the rendering data are switched to the second image data.

Note that in this embodiment, the first image data are all of the sample image data, the fourth image data are a part of the sample image data, the second image data are the slide image data, and the third image data are the gross image data. More specifically, in the display enlargement processing according to this embodiment, the fourth image data are image data (rendering data) for displaying a partial image of the sample at a display magnification one step higher than the lower limit value.

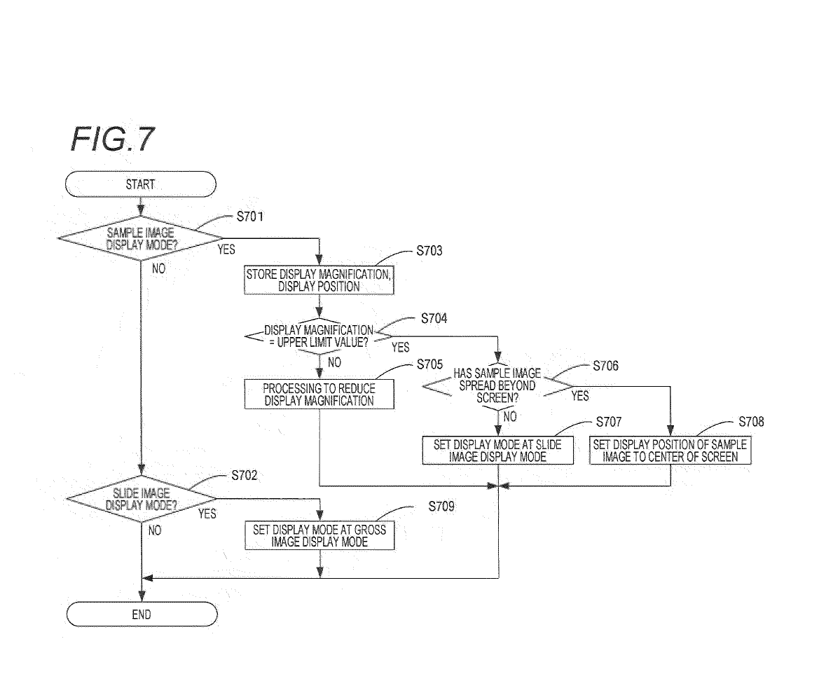

FIG. 7 is a flowchart showing the display reduction processing of step S514.

First, in Step S701, the display mode switching control unit 402 determines whether or not the currently set display mode is the sample image display mode. When the sample image display mode is determined, the processing is advanced to Step S703, and when the sample image display mode is not determined, the processing is advanced to Step S702.

In Step S703, the display mode switching control unit 402 stores the currently set display magnification and display position.

Next, in Step S704, the display mode switching control unit 402 determines whether or not the currently set display magnification is the lower limit value. When the currently set display magnification is determined to be the lower limit value, the processing is advanced to Step S706. When the currently set display magnification is determined not to be the lower limit value, the processing is advanced to Step S705.

In Step S705, the display mode switching control unit 402 sets the display magnification one step lower than the currently set display magnification on the basis of the display magnification switching interval set in Step S501, and then terminates the display reduction processing (returns the processing to Step S503).

In step S706, the display mode switching control unit 402 determines on the basis of the currently set display position whether or not the sample image has spread beyond the screen (whether or not the entire sample is displayed). When it is determined that the entire sample is not displayed, processing of Step S708 is performed, whereupon the display reduction processing is terminated. When it is determined that the entire sample is displayed, processing of Step S707 is performed, whereupon the display reduction processing is terminated.

In Step S707, the display mode switching control unit 402 modifies the display mode setting from the sample image display mode to the slide image display mode.

In Step S708, the display mode switching control unit 402 modifies the set value of the display position so that the entire sample is displayed. For example, the display position is set such that a central position of the sample image corresponds to a central positron of the screen.

In Step S702, the display mode switching control unit 402 determines whether or not the currently set display mode is the slide image display mode.

When the slide image display mode is determined, processing of Step S709 is performed, whereupon the display reduction processing is terminated. In Step S709, the display mode switching control unit 402 modifies the display mode setting from the slide image display mode to the gross image display mode.

When the slide image display mode is not determined, the display reduction processing is terminated.

Hence, when the sample image display mode is set and the set value of the display magnification is not the lower limit value, the display reduction processing is performed to reduce the display magnification of the sample image. Further, when the sample image display mode is set, the sec value of the display magnification is the lower limit value, and a partial image of the sample is displayed, the display position is set such that the entire sample is displayed on the screen. In all other cases, the display mode is modified through the display reduction processing such that an image reduced relative to the currently displayed image is displayed.

Therefore, when the user performs the zoom-out operation in a condition where the fourth image data are displayed, the rendering data are switched to the first image data. When the user performs the zoom-out operation in a condition where the first image data are displayed, the rendering data are switched to the second image data. When the user performs the zoom-out operation in a condition where the second image data are displayed, the rendering data are switched to the third image data.

Note that in the display reduction processing according to this embodiment, the fourth image data may be image data (rendering data) for displaying a partial image of the sample at the lower limit value display magnification.

Alternatively, in the display reduction processing according to this embodiment, the fourth image data may be image data for displaying a partial image of the sample at a display magnification one step above the lower limit value and in a display position where the entire sample is displayed on the screen when the display magnification is set at the lower limit value.

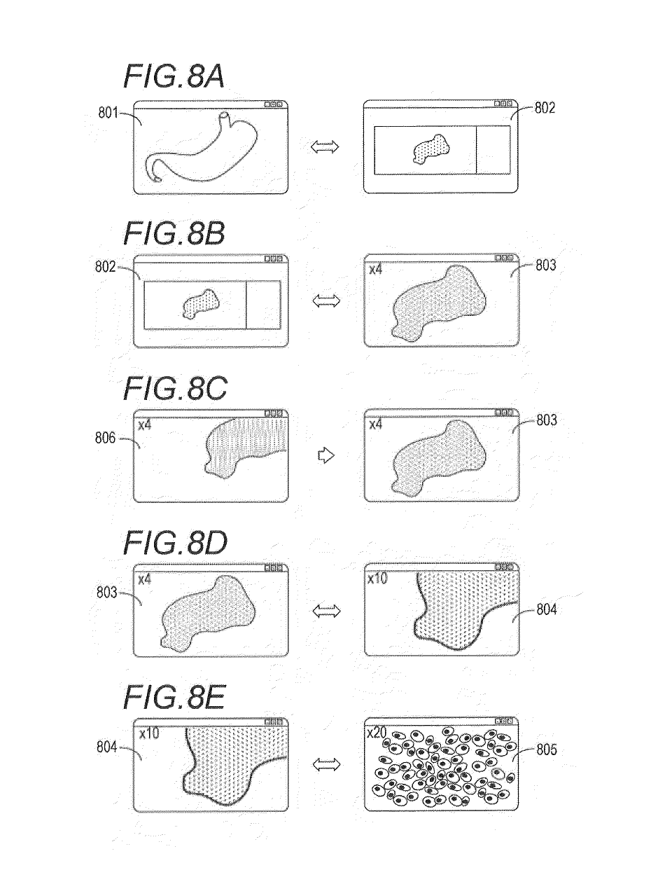

FIGS. 8A to 8E show examples of rendering data switching when the zoom-in operation and the zoom-out operation (an operation to modify the display magnification) according to this embodiment are performed.

FIG. 8A shows an example of rendering data switching when the zoom-in operation is performed in a condition where the gross image display mode is set and the zoom-out operation is performed in a condition where the slide image display mode is set. When the gross image display mode is set, the rendering data (gross rendering data 801) for displaying the full image of the gross sample are displayed. When the slide image display mode is set, the rendering data (slide rendering data 802) for displaying the full image of the slide are displayed. When the user performs the zoom-in operation while the gross rendering data 801 are displayed, it is determined that an instruction to switch the display to the slide rendering data 802 has been issued, and therefore the display mode is switched to the slide image display mode. As a result, the display is switched to the slide rendering data 802. When the user performs the zoom-out operation while the slide rendering data 802 are displayed, it is determined that an instruction to switch the display to the gross rendering data 801 has been issued, and therefore the display mode is switched to the gross image display mode. As a result, the display is switched to the gross rendering data 801.

FIG. 8B shows an example of rendering data switching when the zoom-in operation is performed in a condition where the slide image display mode is set and the zoom-out operation is performed in a condition where rendering data (full rendering data 803) for displaying the full image of the sample are displayed in the sample image display mode. When the user performs the zoom-in operation while the slide rendering data 802 are displayed, it is determined that an instruction to switch the display to the full rendering data 803 has been issued, and therefore the display mode is switched to the sample image display mode. Further, the lower limit value is set as the display magnification and a position in which the entire sample is displayed is set as the display position. As a result, the display is switched to the full rendering data 803. When the user performs the zoom-out operation while the full rendering data 803 are displayed, it is determined that an instruction to switch the display to the slide rendering data 802 has been issued, and therefore the display mode is switched to the slide image display mode. As a result, the display is switched to the slide rendering data 802.

FIG. 8C shows an example of rendering data switching when the zoom-out operation is performed in a condition where the sample image display mode is set and rendering data (partial rendering data 806) for displaying a partial image of the sample at the lower limit value display magnification are displayed. A condition in which the partial rendering data 806 are displayed arises when the user performs an operation to modify the display position while the full rendering data 803 are displayed or the like. When the user performs the zoom-out operation while the partial rendering data 806 are displayed, it is determined that an instruction to switch the display to the full rendering data 803 has been issued, and therefore the display position is modified to the position in which the full rendering data 803 are displayed without modifying the display mode and the display magnification. As a result, the display is switched to the full rendering data 803. Note that it is also determined that an instruction to switch the display to the full rendering data 803 has been issued when the zoom-out operation is performed in a condition where rendering data tor displaying a partial image of the sample at the display magnification one step above the lower limit value and the display position in which the entire sample is displayed on the screen at the lower limit value display magnification are displayed. In this case, the display magnification is modified to the lower limit value without modifying the display mode and the display position. As a result, the display is switched to the full rendering data 803.

FIG. 8D shows an example of rendering data switching when the zoom-in operation is performed to modify the display magnification from 4 times to 10 times and the zoom-out operation is performed to modify the display magnification from 10 times to 4 times in a condition where the sample image display mode is set. It is assumed here that the display magnification of the full rendering data 803 is 4 times. When the user performs the zoom-in operation while the full rendering data 803 are displayed, it is determined that an instruction to switch the display magnification to 10 times has been issued, and therefore the display magnification is modified to 10 times without modifying the display mode and the display position. As a result, the display is switched to rendering data (partial rendering data 804) for displaying a partial image of the sample at the 10 times display magnification. When the user performs the zoom-out operation while the partial rendering data 804 are displayed, it is determined that an instruction to switch the display magnification to 4 times has been issued, and therefore the display magnification is modified to 4 times without modifying the display mode and the display position. As a result, the display is switched to the full rendering data 803.

FIG. 8E shows an example of rendering data switching when the zoom-in operation is performed to modify the display magnification from 10 times to 20 times and the zoom-out operation is performed to modify the display magnification from 20 times to 10 times in a condition where the sample image display mode is set. When the user performs the zoom-in operation while the partial rendering data 804 are displayed, it is determined that an instruction to switch the display magnification to 20 times has been issued, and therefore the display magnification is modified to 20 times without modifying the display mode and the display position. As a result, the display is switched to rendering data (partial rendering data 805) for displaying a partial image of the sample at the 20 times display magnification. When the user performs the zoom-out operation while the partial rendering data 805 are displayed, it is determined that an instruction to switch the display magnification to 10 times has been issued, and therefore the display magnification is modified to 10 times without modifying the display mode and the display position. As a result, the display is switched to the partial rendering data 805. The term “without modifying the display position” means that enlargement or reduction is performed about a predetermined reference point on the display image. The reference point may be selected as desired, for example as a central position of the screen (the image display region), a position of a cursor not shown in the drawings, and so on. For example, when the central position of the screen (the image display region) is set as the reference point, the enlargement processing and reduction processing are performed such that the center of the displayed image does not shift. When a cursor position is set as the reference point, the enlargement processing and reduction processing are performed such that a position with which the user has aligned the cursor (assumed to be an interest position of the user) does not shift.

According to this embodiment, as described above, the full image of the sample, a partial linage of the sample, the full image of the slide, and the full image of the gross sample can be displayed on the display apparatus by switching the display using a simple operation. More specifically, the full image of the sample, a partial image of the sample, the full image of the slide, and the full image of the gross sample can be displayed on the display apparatus by switching the display using conventional zoom-in (enlargement) and zoom-out (reduction) operations. Therefore, the user is not required to perform operations simply for switching the display to the full image of the slide and the full image of the gross sample and an operation for switching to another image display application. Further, when the zoom-out operation is performed during display of the full image of the sample, the sample image is not reduced more than necessary, and therefore the display can be switched to the full image of the slide quickly without performing an unnecessary operation.

According to this embodiment, the full image of the sample, a partial image of the sample, the full image of the slide, and the full image of the gross sample are switched by consistent operations, and therefore the images can be switched and displayed continuously. As a result, an image of the sample can be observed efficiently without paying attention to the operation for switching the image. According to this embodiment, the full image of the sample, a partial image of the sample, the full image of the slide, and the full image of the gross sample can be switched and displayed sequentially by means of an extremely simple operation. In other words, a feature of this embodiment is that the display can be enlarged (gradually) in order from the gross image to a microscope image by repeating the zoom-in operation.

Another feature of this embodiment is that the display can be reduced (gradually) in order from the microscope image to the gross image by repeating the zoom-out operation. With these features, an observer can closely observe an area of interest of a displayed image without effort while varying the magnification in steps. At this time, enlargement and reduction between the gross image and the microscope image can be performed seamlessly without shifting the display position, and therefore the observer loses sight of the area of interest less frequently. As a result, observation and diagnosis can be performed efficiently.

Note that this embodiment is configured such that it is possible so switch between the full image of the sample, a partial image of the sample, the full image of the slide, and the full image of the gross sample using the zoom-in operation and the zoom-out operation. However, the present invention is not limited to this configuration, and may be configured such that it is possible to switch only between the full image of the sample and the full image of the slide using the zoom-in operation and the zoom-out operation. The present invention may also be configured such that it is possible to switch only between the full image of the sample, a partial image of the sample, and the full image of the slide using the zoom-in operation and the zoom-out operation. The present invention may also be configured such that it is possible to switch only between the full image of the sample, the full image of the slide, and the full image of the gross sample using the zoom-in operation and the zoom-out operation. The present invention may also be configured such that it is possible to switch between the full image of the sample, a partial image of the sample, the full image of the slide, and an image other than the full image of the gross sample using the zoom-in operation and the zoom-out operation.

This embodiment is configured such that the rendering data at the set display magnification are generated from a single set of sample image data. However, the present invention is not limited to this configuration, and in a case where a plurality of sample image data are captured at different magnifications, sample image data captured at an identical (or a closest) magnification to the set display magnification may be selected from the plurality of sample image data such that the rendering data at the set display magnification are generated from the selected sample image data.

This embodiment is configured such that the sample image data, slide image data, and gross image data are obtained from an external device, but the image data may be stored in the image processing apparatus. Further, the slide image data may be generated by synthesizing the sample image data with slide glass image data (image data for displaying a full image of a slide glass) prepared in advance. Furthermore, the gross image data may be image data such as an illustration of the gross sample rather than captured image data.

### Second Embodiment

In the first embodiment, image data for displaying only the full image of the slide are displayed in the slide image display mode. In other words, the second image data are image data for displaying only the full image of the slide. In this embodiment, a configuration in which image data for displaying a frame representing the size of the sample and a text image as well as the full image of the slide are displayed in the slide image display mode will be described. In other words, an example of a case in which the second image data are image data for displaying the full image of the slide, a frame representing the size of the sample, and a text image will be described.

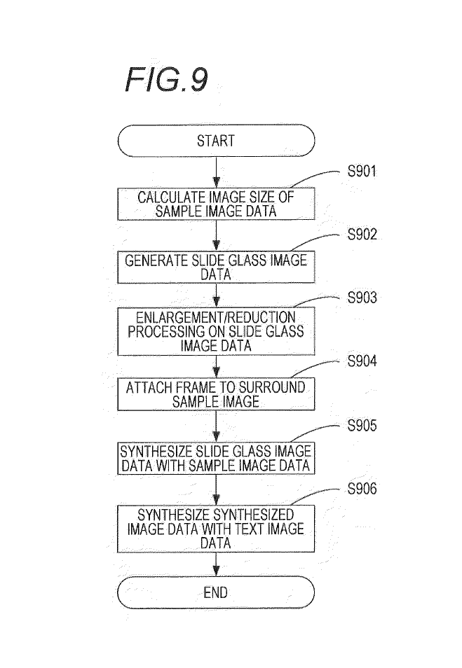

FIG. 9 is a flowchart showing an example of the rendering data generation processing (Step S504 in FIG. 5) performed when the slide image display mode is set. Note that in this embodiment, it is assumed that in Step S503 of FIG. 5, all of the sample image data are obtained when the slide image display mode is set.

First, in Step S901, the rendering data generation unit 403 calculates an image size (a length of the image in a horizontal direction and a vertical direction) of the obtained sample image data. Note that in this embodiment, “mm” is set as a unit of length. However, the unit of length is not limited, to “m”, and “inches”, “pixels”, and so on may be used as the unit of length instead. Further when calculating the length in this embodiment, processing is performed to round off the decimal point (for example, processing to round down, round up, or round off the decimal point).

Next, in Step S902, the rendering data generation unit 403 generates slide glass image data for displaying a full image of a slide glass. Note that the slide glass image data may be stored in advance or generated on the basis of an actual size of the slide glass or the like.

Next, in Step S903, the rendering data generation unit 403 implements enlargement or reduction processing on the obtained sample image data such that a size ratio between the sample image (the full image of the sample) and the slide glass image matches an actual ratio (a size ratio between the sample and the slide glass).

Next, in Step S904, the rendering data generation unit 403 attaches an image of a frame surrounding the sample image to the image data (the size-modified sample image data) obtained in Step S903.

Next, in Step S905, the rendering data generation unit 403 synthesizes the image data (the sample image having the attached frame) obtained in Step S904 with the slide glass image data generated in Step S902. For example, the slide glass image data are synthesized with the image data obtained, in Step S904 such that the sample image having the attached frame is positioned in a predetermined position (a central position, for example) of the slide glass image.

Next, in Step S906, the rendering data generation unit 403 attaches text image data expressing the horizontal direction and vertical direction size of the sample, calculated in Step S901, to the image data obtained in Step S905, whereupon the current processing flow is terminated. The text image data are preferably attached such that the text expressing the horizontal direction size is displayed on a lower side or an upper side of the frame while the text expressing the vertical direction site is displayed on a right side or a left side of the frame. By attaching the text image data in this manner, the user can grasp intuitively that the content of the text refers to the size of the sample. In this embodiment, the text expressing the horizontal direction size of the sample is displayed on the lower side or upper side of the frame while the text expressing the vertical direction size is displayed on the right side or left side of the frame, but the display positions and display method are not limited thereto, and instead, for example, a configuration whereby the user can modify the display positions and the display method may be employed.

Note that the method of generating the image data for displaying the full image of the slide, the frame representing the size of the sample, and the text image is not limited to the above method, and instead, the image data for displaying the full image of the slide, the frame representing the size of the sample, and the text image may be generated by attaching a frame and a text image to the slide image data.

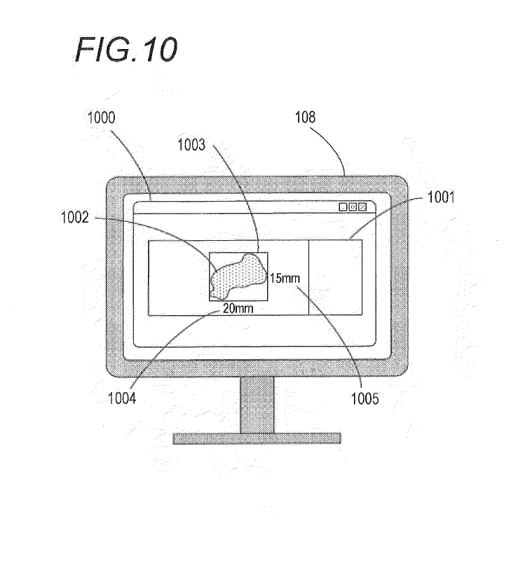

FIG. 10 shows a display example of image data tor displaying the full image of the slide, a frame representing the size of the sample, and a text image.

A reference numeral 1000 denotes a window in which the image data for displaying the full image of the slide, the frame representing the size of the sample, and the text image are displayed. A size of the window 1000 may be identical to or different from the size of the screen of the display apparatus 108.

A reference numeral 1001 denotes the slide glass image.

A reference numeral 1002 denotes the sample image. In the example of FIG. 10, the position of the sample image 1002 is set as a central position of the slide glass image. Further, the size ratio between the sample image 1002 and the slide glass image 1001 is set to be identical to the actual ratio (the size ratio between the sample and the slide glass).

A reference numeral 1003 denotes the frame surrounding the sample image.

Reference numerals 1004, 1005 denote the text images expressing the size of the sample. The text image 1004 expresses the horizontal direction size of the sample, and the text image 1005 expresses the vertical direction size of the sample. The text images 1004, 1005 are numerical value images from which decimal places have been omitted. Note that in this embodiment, an example in which numerical value images rounded off to the decimal point are displayed so that the user can grasp the size intuitively will be described, but the methods of calculating and displaying the size of the sample are not limited thereto. For example, numerical values to the first decimal place may be displayed as the numerical values expressing the size of the sample. The number of significant figures of the numerical values expressing the size of the sample may be set at two differences in power, three differences in power, and so on. Further, numerical values expressing the size of the sample without rounding off the decimal point may be displayed. There are no particular limitations on the calculation precision of the sample size.

According to this embodiment, as described above, in the slide image display mode, image data for displaying the full image of the slide and the images (the frame and the text image) expressing the size of the sample are displayed. As a result, a quantitative size of the sample can also be grasped easily.

Note that in this embodiment, both the frame and the text image are displayed, but only one of the frame or the text image may be displayed. Likewise with this configuration, an effect corresponding to the effect described above can be obtained.

It is assumed in this embodiment that the image data for displaying the full image of the slide and the images expressing the size of the sample are generated in the image processing apparatus. However, the image data may be obtained from an external device.

### Third Embodiment

In the first and second embodiments, the first image data are the image data for displaying only the full image of the sample. In this embodiment, an example of a case in which the first image data are image data for displaying the full image of the sample and the full image of the slide glass on which the sample is provided (i.e. a full image of a slide) will be described. Further, in the first and second embodiments, the third image data are the image data for displaying only the full image of the gross sample. In this embodiment, an example of a case in which the third image data are image data for displaying the full image of the gross sample and the full image of the slide will be described.

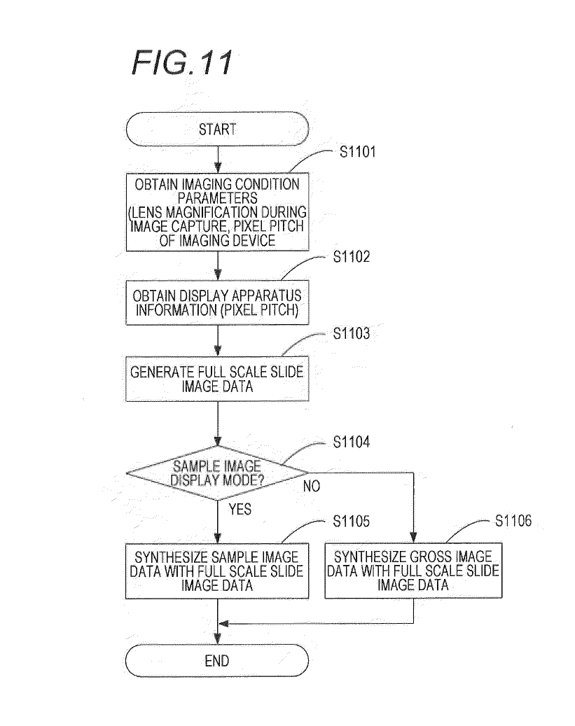

FIG. 11 is a flowchart showing an example of the rendering data generation processing (Step S504 in FIG. 5) performed when the sample image display mode or the gross image display mode is set. Note that in this embodiment, it is assumed that in Step S503 of FIG. 5, the slide image data are obtained in addition to the sample image data when the sample image display mode is set. Further, it is assumed that when the gross image display mode is set, the slide image data are obtained in addition to the gross image data.

First, in Step S1101, the rendering data generation unit 403 obtains the imaging conditions (imaging condition parameters) of the image data obtained in Step S503. The imaging conditions are the lens magnification during image capture, the pixel pitch of the imaging device, and so on.

Next, in Step S1102, the rendering data generation unit 403 obtains information indicating a display pixel pitch of the display apparatus 108.

Next, in Step S1103, the rendering data generation unit 403 implements enlargement processing or reduction processing on the slide image data on the basis of the information obtained in Steps S1101 and S1102. In this embodiment, the slide image data are enlarged or reduced such that the display size of the full image of the slide is identical to an actual size, regardless of specifications of the display apparatus 108. More specifically, the slide image data are enlarged or reduced at an enlargement ratio or a reduction ratio obtained from the following expression:

{(Lens Magnification during image capture)}/{(Pixel Pitch of imaging device)/(Display Pixel Fitch of display apparatus 108)}. 1

Next, in Step S1104, the rendering data generation unit 403 determines whether the set display mode is the sample image display mode or the gross image display mode. When the sample image display mode is determined, the processing is advanced to Step S1105, and when the gross image display mode is determined, the processing is advanced to Step S1106.

In Step S1105, the rendering data generation unit 403 generates rendering data using the sample image data obtained in Step S503 and the slide image data (full size slide image data; full scale slide image data) generated in Step S1103. For example, the rendering data generation unit 403 generates sample image data (the rendering data obtained in the first embodiment) to be displayed on the display apparatus from the sample image data obtained in Step S503, and then generates the rendering data by synthesizing the generated sample image data with the full scale slide image data.

Note that according to this configuration, when at least a part of the sample image data are displayed, the full scale slide image data are synthesized with the displayed sample image data. However, the present invention is not limited to this configuration, and for example, a determination as to whether or not the full image of the sample is displayed may be made from the display magnification and the display position, and the generated image data may be synthesized with the full scale slide image data only when the full image of the sample (all of the sample image data) is displayed.

In Step S1106, the rendering data generation unit 403 generates the rendering data by synthesizing the gross image data obtained in Step S503 with the full scale slide image data generated in Step S1103.

By performing the processing described above, rendering data for displaying the full image of the slide together with the image of the sample (the full image or a partial image) and the full image of the gross sample are generated.

Note that in this embodiment, a configuration in which the display size of the full image of the slide displayed together with the image of the sample (the full image or a partial image) and the full image of the gross sample is set to be identical to the actual size was described. However, the present invention is not limited to this configuration, and the display size of the full image of the slide displayed together with the image of the sample (the full image or a partial image) and the full image of the gross sample may be larger or smaller than the actual size. Further, by performing similar processing to that of Steps S1101 to S1103 in the slide image display mode, rendering data for displaying the full image of the slide at full size may be generated.

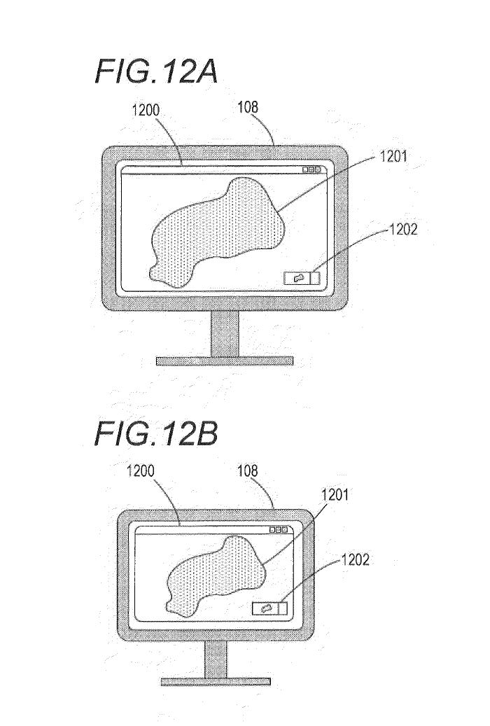

FIGS. 12A and 12B are views showing display examples of the image data for displaying the full image of the sample together with the full image of the slide glass on which the sample is provided (i.e. the full image of the slide). The screen of the display apparatus 108 in FIG. 12A and the screen of the display apparatus 108 in FIG. 12B differ from each other in size.

A reference numeral 1200 denotes the window in which the image data for displaying the full image of the sample and the full image of the slice are displayed. The window 1200 is displayed on the screen of the display apparatus 108.

A reference numeral 1201 denotes the sample image. More specifically, the sample image 1201 is the full image of the sample.

A reference numeral 1202 denotes the slide image (the full image of the slide). According to this embodiment, as shown in FIGS. 12A and 12B, the slide image 1202 is displayed at a fixed size (at full size, for example), independently of the size and resolution of the screen of the display apparatus 108.

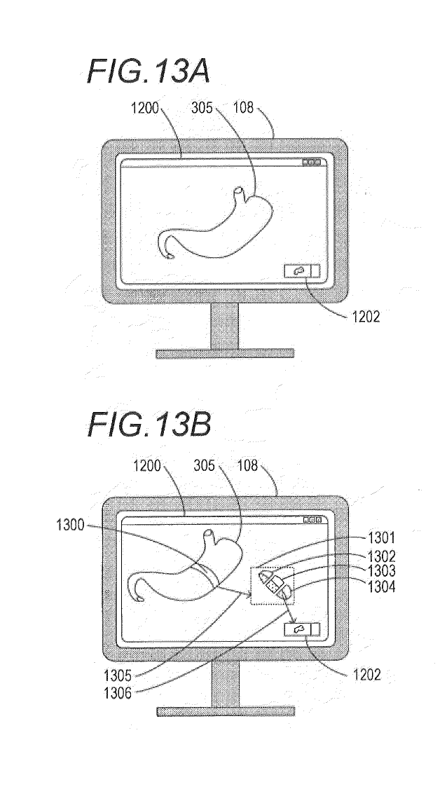

FIGS. 13A and 13B are views showing display examples of the image data for displaying the full image of the gross sample together with the full image of the slide. In an example shown in FIG. 13A, the gross image 305 and the slide image 1202 are displayed simultaneously. In other words, the rendering data generated in Step S1106 are displayed in the window 1200. When the slide image 1202 is displayed at full size, the gross image 305 may also be displayed at full size. Alternatively, respective ratios between the sizes of the slide image 1202 and the gross image 305 and the corresponding full sizes may be set to be identical.

In an example shown in FIG. 13B, images for connecting the processes used to create the slide image data 1202 from the gross sample 304 are displayed. A reference numeral 1300 denotes a position in which a part of the gross sample is cut out from the entire gross sample 304, i.e. the site of the suspected pathological abnormality in the organ. A reference numeral 1301 denotes a display example of an image of the part of the gross sample cut out from the entire gross sample 304 when the gross sample 304 is fixed by formalin or the like. Reference numerals 1302 to 1304 denote display examples of a plurality of parts cut from the part 1301 of the gross sample centering on the vicinity of the pathological abnormality. A reference numeral 1305 denotes a display example of an image indicating that a correspondence relationship exists between the partial image 1301 of the gross sample, the gross sample 304 serving as the cutting source, and the cutting position 1300. A reference numeral 1306 denotes a display example of an image indicating that a correspondence relationship exists between the image of the part 1304 of the gross sample and the slide 1202 carrying the sample obtained by embedding the part 1304 of the gross sample in paraffin (wax) and sectioning the embedded part 1304 using a microtome or the like. In this embodiment, an example in which the part 1301 of the gross sample is cut out from the entire gross sample 304 and the part 1301 of the gross sample is further divided into three parts is illustrated, but the present invention is not limited thereto. Further, the image indicating the cutting position having the reference numeral 1300 and the images indicating the correspondence relationships to the cutting position, having the reference numerals 1305 and 1306, may be attached in advance before capturing the respective images or attached manually or automatically following image capture using an image editing application or the like. The display examples according to this embodiment are solid lines and arrows, but the display examples are not limited thereto.

According to this embodiment, as described above, the full image of the slide is displayed together with the sample image, the full image of the gross sample, or a partial image of the gross sample. Hence, even in a display mode other than the slide image display mode, an image that serves as a comparison to the size of the sample image is displayed, and therefore the size of the sample relative to the size of the gross sample and the slide can be grasped.

Further, according to this embodiment, the full image of the slide is displayed at full size (real size). Therefore, a sense of the actual size of the slide, which is important for diagnosing (observing) the sample, can be obtained regardless of the display apparatus. Moreover, correct information such as the origin (the gross sample) of the sample, the overall condition of the origin (the gross sample) of the sample (i.e. whether or not the sample was cut from an appropriate position of the gross sample), and a correspondence relationship between the sample and the origin (the gross sample) of the sample can be obtained. As a result, the size, degree of advancement, and so on of a pathological abnormality such as a tumor or a carcinoma can be grasped correctly, enabling correct diagnosis (observation).

### Fourth Embodiment

In the first embodiment, an example of rendering data switching during the zoom-in operation and the zoom-out operation (operations for modifying the display magnification) was described. In this embodiment, an example in which the rendering data are switched and displayed in accordance with the image display mode and a cursor position during the zoom-in operation and the zoom-out operation (operations for modifying the display magnification) will be described. In the first embodiment, an example in which the display mode switching control unit 402 switches the display mode between the sample image display mode, the slide image display mode, and the gross image display mode on the basis of an input operation instruction was described. In this embodiment, an example in which the display mode is switched between a gross partial image display mode, a slide image list display mode, an electron microscope image display mode, a clinical image display mode, and a patient list image display mode in addition to the various aforesaid display modes will be described.

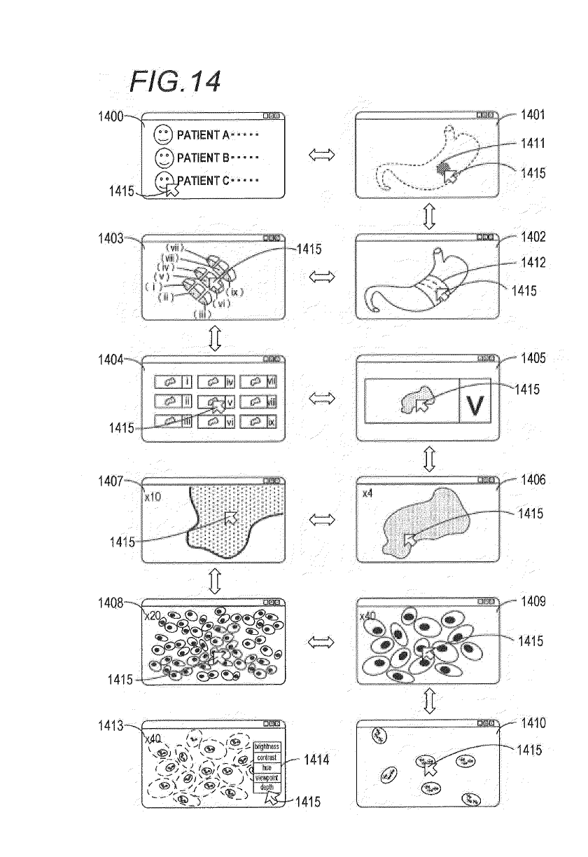

FIG. 14 shows an example in which a patient list, a clinical image, the full image of the gross sample, a partial image of the gross sample, a plurality of slide images (a thumbnail image list), the full image of the slide, the full image of the sample, a partial image of the sample, a partial image of the sample at a maximum display magnification, and an electron microscope image are switched and displayed by performing the zoom-in operation or the zoom-out operation in a cursor position. When the display mode is the sample image display mode, all or a part of the sample image data are displayed. In the slide image display mode, the slide image data are displayed. In the gross image display mode, the gross image data (the full image of the gross sample) are displayed. In the gross partial image display mode, gross partial image data are displayed. In the slide image list display mode, image data of a plurality of slides are displayed. In the electron microscope image display mode, electron microscope image data are displayed. In the clinical image display mode, clinical image data are displayed. In the patient list image display mode, patient list image data, to be described below, are displayed.

A reference numeral 1400 denotes an example in which the patient list image display mode is set such that rendering data (ninth image data) for displaying a patient list are displayed. In this example, a patient list (Patient A to Patient C) is displayed, and a selection cursor 1415 is in a position of Patient C. When the user performs the zoom-in operation in a condition where the patient list image display mode is set and the selection cursor 1415 is in the position of Patient C, it is determined that Patient C has been selected, and the display mode is switched to the clinical image display mode. Accordingly, the rendering data are switched to rendering data (eighth image data; rendering data hawing a reference numeral 1401) for displaying a clinical image of the patient (Patient C). As the rendering data (the ninth image data) for displaying the patient list, the patient list image is exemplified. However, the present invention is not limited thereto, and instead, an electronic chart (medical record) or a display screen of an ordering system may be displayed. Alternatively, another display mode may be set when the zoom-in operation is performed.

The reference numeral 1401 denotes an example in which the clinical image display mode is set such that the rendering data (the eighth image data) for displaying a clinical image (an image of all or a part of a human body, captured using X-ray camera, a CT scanner, an MRI scanner, a PET scanner, a fundus camera, an endoscope, a scanner, or the like prior to extraction of the sample from the body) are displayed. In this example, a clinical image of a part of the body of the patient (Patient C), captured by X-ray or the like, is displayed. A reference numeral 1411 indicates that a site of a suspected pathological abnormality exists in the clinical image of the captured part of the body of the patient. Further, the selection cursor 1415 is in the position of the suspected pathological abnormality. When the user performs the zoom-in operation in a condition where the clinical image display mode is set and the selection cursor 1415 is positioned in the site of the suspected pathological abnormality, it is determined that an instruction to display a full image of a gross sample extracted by an operation and corresponding to the site of the suspected pathological abnormality has been issued, and accordingly, the display mode is switched to the gross image display mode. The rendering data are then switched to the rendering data (the third image data; rendering data having a reference numeral 1402) for displaying the full image of the gross sample corresponding to the site of the suspected pathological abnormality. Further, when the user performs the zoom-out operation in a condition where the clinical image display mode is set, it is determined that an instruction for returning to display of the patient list has been issued, and therefore the display mode is switched to the patient list image display mode. The rendering data are then switched to the rendering data (the ninth image data; the rendering data having the reference numeral 1400) for displaying the patient list. In this example, the display mode is switched to the gross full image display mode when the selection cursor 1415 is in the position of the suspected pathological abnormality, but the present invention is not limited thereto, and the display mode may be switched to another display mode when the zoom-in operation and the zoom-out operation are performed.

The reference numeral 1402 denotes an example in which the gross image display mode is set such that the rendering data (the third image data) for displaying the full image of the gross sample are displayed. The displayed full image of the gross sample is an image of all or a part of an organ corresponding to the site 1411 of the suspected pathological abnormality, such as a tumor or a carcinoma, extracted from the body by an operation. Further, the selection cursor 1415 is in the position of the suspected pathological abnormality. When the user performs the zoom-in operation in a condition where the gross image display mode is set and the selection cursor 1415 is positioned in the site of the suspected pathological abnormality, it is determined that an instruction to display a partial image of the gross sample including the site 1411 of the suspected pathological abnormality and a site 1412 on the periphery thereof has been issued, and accordingly, the display mode is switched to the gross partial image display mode. The rendering data are then switched to rendering data (sixth image data; rendering data having a reference numeral 1403) for displaying a partial image of the gross sample including the site 1411 of the suspected pathological abnormality and the site 1412 on the periphery thereof. Further, when the user performs the zoom-out operation in a condition where the gross partial image display mode is set, it is determined that an instruction for returning to display of the clinical image has been issued, and therefore the display mode is switched to the clinical image display mode. The rendering data are then switched to the rendering data (the eighth image data; the rendering data having the reference numeral 1401) for displaying the clinical image. In this example, the display mode is switched to the gross partial image display mode when the selection cursor 1415 is in the position of the suspected pathological abnormality, but the present invention is not limited thereto, and the display mode may be switched to another display mode when the zoom-in operation and the zoom-out operation are performed.

The reference numeral 1403 denotes an example in which the gross partial image display mode is set such that tire rendering data (the sixth image data) for displaying the partial image of the gross sample are displayed. The displayed partial image of the gross sample is an image of a part of an organ, obtained by cutting out the site 1411 of the suspected pathological abnormality and the site 1412 on the periphery thereof from the entire gross sample in order to create a slide. Further, reference symbols (i) to (ix), displayed within the reference numeral 1403, are examples of text images representing indices of various gross partial images. In this example, the text images having the reference symbols (i) to (ix) and the corresponding partial images of the gross sample are linked by solid leader lines. The images having the reference symbols (i) to (ix) may be attached in advance before capturing the partial images of the gross sample, or attached manually or automatically following image capture using an image editing application or the like. In this embodiment, correspondence relationships between the reference symbols (i) to (ix) and the various partial images of the gross sample are indicated by solid line, but the present invention is not limited thereto. Note that in this example, the gross sample is cut into nine pieces having the reference symbols (i) to (ix), but the present invention is not limited thereto. The reference symbols (i) to (ix) indicate correspondence relationships to labels i to ix on respective slides of the plurality of slide images (the thumbnail image list), to be described below. Furthermore, the selection cursor 1415 is in the vicinity of the gross sample cut from the position of the suspected pathological abnormality (the site 1411 of the suspected pathological abnormality). When the user performs the zoom-in operation in a condition where the gross partial image display mode is set and the selection cursor 1415 is in the vicinity of the gross sample cut from the position of the suspected pathological abnormality, it is determined that an instruction to display the rendering data for displaying the plurality of slide images (the thumbnail image list) created from the part 1403 or the gross sample has been issued, and accordingly, the display mode is switched to the slide image list display mode. The rendering data are then switched to rendering data (fifth image data; rendering data having a reference numeral 1404) for displaying the plurality of slide images (the thumbnail image list). Further, when the user performs the zoom-out operation in a condition where the gross partial image display mode is set, it is determined that an instruction for returning to display of the full image of the gross sample has been issued, and therefore the display mode is switched to the gross image display mode. The rendering data are then switched to the rendering data (the third image data; the rendering data having the reference numeral 1402) for displaying the full image of the gross sample. In this example, the display mode is switched to the slide image list display mode when the selection cursor 1415 is in the position of the suspected pathological abnormality, but the present invention is not limited thereto, and the display mode may be switched to another display mode when the zoom-in operation or the zoom-out operation is performed. The slide labels are set at indices i to ix, but are not limited thereto, and any desired image and text combinations, such as sample numbers, branch numbers, serial section numbers, or two-dimensional codes, may be used. Further, instead of adhering the labels to the slides in the form of a seal, the labels may be printed or engraved directly onto the slides, embedded in the form of non-contact chips, and so on.

The reference numeral 1404 denotes an example in which the slide image list display mode is set such that the rendering data (the fifth image data) for displaying the plurality of slide images (the thumbnail image list) are displayed. Samples carried on respective slides i to ix, displayed in the plurality of displayed slide images (the thumbnail image list) 1404 are formed by creating paraffin blocks from the respective parts 1403 (i) to (ix) of the gross sample and sectioning the paraffin blocks. For example, a sample formed by embedding the part 1403 (i) of the gross sample in paraffin to create a paraffin block and sectioning the paraffin block is carried on a slide glass to serve as the slide i. The slides ii To ix are formed similarly. Further, the selection cursor 1415 is in the position of the slide v. When the user performs the zoom-in operation in a condition where the slide image list display mode is set and the selection cursor 1415 is in the position of the slide v, it is determined that the slide v has been selected, and accordingly, the display mode is switched to the slide image display mode. The rendering data are then switched to the rendering data (the second image data; rendering data hawing a reference numeral 1405) for displaying the full image of the slide. Further, when the user performs the zoom-out operation in a condition where the slide image list display mode is set, it is determined that an instruction for returning to display of the partial image of the gross sample has been issued, and therefore the display mode is switched to the gross partial image display mode. The rendering data are then switched to the rendering data (the sixth image data; the rendering data having the reference numeral 1403) for displaying the partial image of the gross sample. In this example, the display mode is switched to the slide image display mode of the slide v when the selection cursor 1415 is in the position of the slide v, but the present invention is not limited thereto, and the display mode may be set at another display mode when the zoom-in operation or the zoom-out operation is performed. Further, the plurality of slide images (the thumbnail image list) may be a list of image file names, a thumbnail list, or a list combining a thumbnail list and file names. Furthermore, the number of slides displayed at one time may be all of the image files or at least two of the image files. By indicating correspondence relationships between the plurality of slide images (the thumbnail image list) and the partial images of the gross sample using the reference numerals 1403 to 1404 in this manner so that a desired sample can be observed, the degree of advancement of the pathological abnormality can be grasped. In a specific example, the samples having the reference numerals 1404 (i) to 1404 (ix) are observed, and when no pathological abnormalities such as tumors or carcinomas are found on any slides other than the slide having the reference numeral 1404 (v), it can be confirmed that the site 1411 of the suspected pathological abnormality has been entirely cut out by an operation such that no pathological abnormality exists outside of the reference numeral 1412.

The reference numeral 1405 denotes an example in which the slide image display mode is set such that the rendering data (the second image data) for displaying the full image of the slide are displayed. In this example of the displayed full image of the slide, a full image of the slide v from among the plurality of slide images (the thumbnail image list) 1404 is displayed over the entire screen. Further, the selection cursor 1415 is in a sample carrying position of the slide v. When the user performs the zoom-in operation in a condition where the slide image display mode is set, it is determined that an instruction to display a full image of the sample has been issued, and accordingly, the display mode is switched to the sample image display mode. The rendering data are then switched to rendering data (first image data; rendering data having a reference numeral 1406) for displaying a full image of the sample. Further, when the user performs the zoom-out operation in a condition where the slide image display mode is set, it is determined that an instruction for returning to display of the plurality of slide images (the thumbnail image list) has been issued, and therefore the display mode is switched to the slide image list display mode. The rendering data are then switched to the rendering data (the fifth image data; the rendering data having the reference numeral 1404) for rendering the plurality of slide images. In this example, the selection cursor 1415 is in the position of the sample on the slide v, but the present invention is not limited thereto, and the selection cursor 1415 may be positioned elsewhere. Furthermore, the display mode may be set at another display mode when the zoom-in operation or the zoom-out operation is performed.

The reference numeral 1406 denotes an example in which the sample image display mode is set and the rendering data for displaying the full image of the sample are displayed. In this embodiment, the full image of the sample is displayed at a display magnification of 4 times. In this example of the displayed full image of the sample, an image of the sample carried on the slide v is displayed over the entire screen. Further, the selection cursor 1415 is positioned on the displayed sample image. When the user performs the zoom-in operation in a condition where the display magnification is set at 4 times and the selection cursor 1415 is positioned on the displayed sample image, it is determined that an instruction to switch the display magnification to 10 times about the center of the selection cursor 1415 has been issued. Accordingly, the display magnification is set at 10 times about the selection cursor 1415, and as a result, the display is switched to rendering data (fourth image data; rendering data having a reference numeral 1407) for displaying a partial image of the sample at a display magnification of 10 times. Further, when the user performs the zoom-out operation in a condition where the sample image display mode is set and the full image of the sample is displayed (i.e. the display magnification is set at 4 times), it is determined that an instruction for returning to display of the full image of the sample has been issued, and therefore the display mode is switched to the slide image display mode. The rendering data are then switched to the rendering data (the second image data; the rendering data having the reference numeral 1405) for rendering the full image of the slide. In this example, the selection cursor 1415 is positioned on the displayed sample image, but the present intention is not limited thereto. Furthermore, the display mode may be set at another display mode when the zoom-in operation or the zoom-out operation is performed.

The reference numeral 1407 denotes an example in which the sample image display mode is set and the rendering data for displaying a partial image of the sample are displayed. In this embodiment, the partial image of the sample is displayed at a display magnification of 10 times. Further, the selection cursor 1415 is positioned on the displayed sample image. When the user performs the zoom-in operation in a condition where the display magnification is set at 10 times and the selection cursor 1415 is positioned on the displayed sample image, it is determined that an instruction to switch the display magnification to 20 times about the center of the selection cursor 1415 has been issued. Accordingly, the display magnification is set at 20 times about the selection cursor 1415, and as a result, the display is switched to rendering data (the fourth image data; rendering data having a reference numeral 1408) for displaying a partial image of the sample at a display magnification of 20 times. Further, when the user performs the zoom-out operation in a condition where the display magnification is set at 10 times and the selection cursor 1415 is positioned on the displaced sample image, it is determined that an instruction for returning the display magnification to 4 times about the selection cursor 1415 has been issued. Accordingly, the display magnification is set at 4 times about the selection cursor 1415, and as a result, the display is switched to the rendering data (the first image data; the rendering data having a reference numeral 1406) for displaying the full image of the sample at a display magnification of 4 times. In this example, the selection cursor 1415 is positioned on the displayed sample image, but the present invention is not limited thereto. Furthermore, the display mode may be set at another display mode when the zoom-in operation or the zoom-out operation is performed.

The reference numeral 1408 denotes an example in which the sample image display mode is set and the rendering data for displaying a partial image of the sample are displayed. In this embodiment, the partial image of one sample is displayed at a display magnification of 20 times. Further, the selection cursor 1415 is positioned on the displayed sample image. When the user performs the zoom-in operation in a condition where the display magnification is set at 20 times and the selection cursor 1415 is positioned on the displayed sample image, it is determined that an instruction to switch the display magnification to 40 times about the center of the selection cursor 1415 has been issued. Accordingly, the display magnification is modified to 40 times about the selection cursor 1415, and as a result, the display is switched to rendering data (the fourth image data; rendering data having a reference numeral 1409) for displaying a partial image of the sample at a display magnification of 40 times. Further, when the user performs the zoom-out operation in a condition where the display magnification is set at 20 times and the selection cursor 1415 is positioned on the displayed sample image, it is determined that an instruction for switching the display magnification to 10 times about the selection cursor 1415 has been issued. Accordingly, the display magnification is modified to 10 times about the selection cursor 1415, and as a result, the display is switched to the rendering data (the fourth image data; the rendering data having a reference numeral 1407) for displaying a partial image of the sample at a display magnification of 10 times. In this example, the selection cursor 1415 is positioned on the displayed sample image, but the present invention is not limited thereto. Furthermore, the display mode may be set at another display mode when the zoom-in operation or the zoom-out operation is performed.

The reference numeral 1409 denotes an example in which the sample image display mode is set and the rendering data for displaying a partial image of the sample at the maximum display magnification are displayed. In this embodiment, the partial image of the sample is displayed at the maximum display magnification of 40 times. Further, the selection cursor 1415 is positioned on the displayed sample image. When the user performs the zoom-in operation in a condition, where the display magnification is set at the maximum display magnification of 40 times and the selection cursor 1415 is positioned on the displayed sample image, it is determined that an instruction to switch to the electron microscope image has been issued, and accordingly, the display mode is set at the electron microscope image display mode. The display is then switched to rendering data (seventh image data; rendering data having a reference numeral 1410) for displaying an image of the sample indicated by the selection cursor 1415 resulting from image capture by an electron microscope. Further, when the user performs the zoom-out operation in a condition where the display magnification is set at the maximum display magnification of 40 times and the selection cursor 1415 is positioned on the displayed sample image, it is determined that an instruction tor switching the display magnification to 20 times about the selection cursor 1415 has been issued. Accordingly, the display magnification is modified to 20 times about the selection cursor 1415, and as a result, the display is switched to the rendering data (the fourth image data; the rendering data having a reference numeral 1408) for displaying a partial image of the sample at a display magnification of 20 times. In this example, the selection cursor 1415 is positioned on the displayed sample image, but the present invention is not limited thereto. Furthermore, the maximum display magnification is set at 40 times but is not limited thereto. The seventh image data (the rendering data having the reference numeral 1410) correspond to an image of the sample indicated by the selection cursor 1415 resulting from image capture by an electron microscope, but may correspond to an image obtained by a mass microscope, an optical microscope, a scanning probe microscope, an X-ray microscope, an ultrasound microscope, or the like. In this example, the display magnification is switched between 4 times, 10 times, 20 times, and 40 times, but the present invention is not limited thereto, and the display magnification may be switched continuously rather than in steps. Moreover, the display mode may be set at another display mode when the zoom-in operation or the zoom-out operation is performed.

The reference numeral 1410 denotes an example in which the electron microscope image display mode is set such that the rendering data (the seventh image data) for displaying an electron microscope image are displayed. Further, the selection cursor 1415 is positioned on the displayed sample image. When the user performs the zoom-in operation in a condition where the electron microscope image display mode is set and the selection cursor 1415 is positioned on the displayed sample image, it is determined that there are no more rendering data to be switched to, and therefore the rendering data are not switched. Further, when the user performs the zoom-out operation in a condition where the electron microscope image display mode is set and the selection cursor 1415 is positioned on the displayed sample image, it is determined that an instruction for switching the display magnification to 40 times about the selection cursor 1415 has been issued, and therefore the display mode is switched to the sample image display mode. Further, the display magnification is set at 40 times. As a result, the display is switched to the rendering data (the fourth image data; the rendering data having a reference numeral 1409) for displaying a partial image of the sample at a display magnification of 40 times about the selection cursor 1415. Alternatively, the display mode may be set at another display mode when the zoom-in operation or the zoom-out operation is performed.

The reference numeral 1413 denotes an example in which an operating panel having a reference numeral 1414 is displayed simultaneously with the rendering data having the reference numeral 1409 (the rendering data for displaying a partial image of the sample at the maximum display magnification). In this embodiment, the operating panel 1414 is constituted by an image operation menu for adjusting the brightness, contrast, hue, depth, viewpoint, and so on. In this example, the operating panel is used to perform image operations such as brightness adjustment, contrast adjustment, hue adjustment, viewpoint position adjustment, and depth position adjustment on the displayed rendering data having the reference numeral 1409 and reflecting the operation in the rendering data. In this example, the selection cursor 1415 is positioned on the depth switching menu of the operating panel 1414. When the user performs the zoom-in operation or the zoom-out operation in a condition where the selection cursor 1415 is on the depth switching menu of the operating panel 1414, a depth position of the displayed rendering data is increased or reduced by one step, the modified depth position is reflected in the rendering data, and the display is switched to the rendering data reflecting the modification. In this display example, by switching the depth position, a structure in a nucleus of a thick cell can be seen more clearly. Instructions relating to the brightness, contrast, hue, viewpoint position, and other menus are likewise reflected in the rendering data. As a result, the image display is switched such that a cell or a structure within a nucleus is displayed in a more easily recognizable manner. Further, when the user performs the zoom-in operation in a condition where the selection cursor 1415 is not positioned on the operating panel 1414, it is determined that an instruction for switching the display magnification to the electron microscope image has been issued, and therefore the display mode is switched to the electron microscope image display mode. Further, the display is switched to the rendering data (the seventh image data; the rendering data having a reference numeral 1410) for displaying the image of the sample indicated by the selection cursor 1415 resulting from image capture by an electron microscope. Furthermore, when the user performs the zoom-out operation in a condition where the selection cursor 1415 is not positioned on the operating panel 1414, it is determined that an instruction for switching the display magnification to 20 times about the selection cursor 1415 has been issued. Accordingly, the display magnification is set at 20 times about the selection cursor 1415, and as a result, the display is switched to the rendering data (the fourth image data; the rendering data having a reference numeral 1408) for displaying a partial image of the sample at a display magnification of 20 times. The operating panel 1414 is constituted by an image operation menu including brightness, contrast, hue, depth, viewpoint, and so on, but another image operation menu may be displayed. Further, the display mode may be set at another display mode when the zoom-in operation or the zoom-out operation is performed in a condition where the selection cursor 1415 is not positioned on the operating panel 1414.

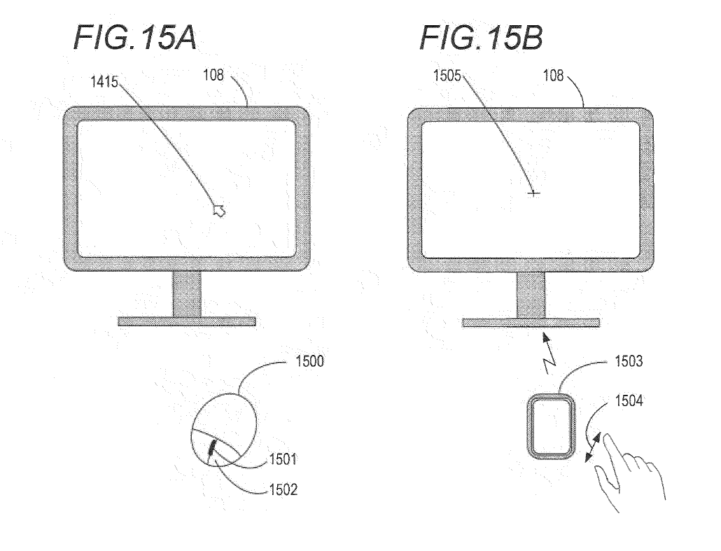

FIGS. 15A and 15B show examples of the display apparatus for displaying the rendering data and an operating device into which the user inputs operation instructions. In FIG. 14, an example in which the rendering data are switched by performing the zoom-in operation and the zoom-out operation in the position of the selection cursor 1415 was described. In FIGS. 15A and 15B, a method of moving the selection cursor or the display position of the rendering data and a method of performing the zoom-in operation and the zoom-out operation will be described.

FIG. 15A shows an example in which the selection cursor 1415 is displayed on the display apparatus 108 and the selection cursor 1415 is operated by an operating device 1500 (a mouse). When the operating device 1500 is operated in a Y direction, for example, the selection cursor 1415 displayed on the display apparatus 108 moves accordingly in the Y direction. When the operating device 1500 is operated in an Y direction, the selection cursor 1415 displayed on the display apparatus 108 moves accordingly in the X direction. A reference numeral 1502 denotes an example of a selection button (a left side button of the mouse) for issuing an operation instruction to move the display position of the rendering data displayed in the position of the selection cursor 1415. For example, when the selection button 1502 is pressed in a condition where the rendering data of the partial image of the sample are displayed on the display apparatus 108, the partial image of the sample is selected. When the operating device 1500 (the mouse) is moved while keeping the selection button 1502 pressed (in other words, when a drag operation is performed), it is determined that a display position modification instruction has been issued, and the display position of the partial image of the sample is modified (scrolled). In this example, the display position of the partial image of the sample is modified, but the present invention is not limited thereto, and the display position of another image may be modified. A reference numeral 1501 denotes an example of an operation instruction button (a mouse wheel) for issuing a display enlargement instruction and a display reduction instruction. For example, when an operation is performed to rotate the mouse wheel, a display enlargement instruction/a display reduction instruction is input. More specifically, when a zoom-out operation is performed by rotating the mouse wheel in a rearward direction, a display reduction instruction is input, and when a zoom-in operation is performed by rotating the mouse wheel in a frontward direction, a display enlargement instruction is input. For example, when the user performs the zoom-in operation in a condition where the rendering data (the fifth image data) for displaying the plurality of slide images (the thumbnail image list) are displayed on the display apparatus 108, it is determined that the slide displayed in the position of the selection cursor 1415 has been selected. Accordingly, the rendering data are switched to the rendering data (the second image data) for displaying the full image of the slide. Further, when the user performs the zoom-out operation in a condition where the rendering data for displaying a partial image of the sample are displayed on the display apparatus 108 at the 20 times display magnification, it is determined that an instruction to switch the display magnification to 10 times about the selection cursor 1415 has been issued, and accordingly, the display magnification is modified to 10 times. As a result, the display is switched to the rendering data (the fourth image data) for displaying a partial image of the sample at a display magnification of 10 times about the selection cursor 1415.

FIG. 15B shows an example in which a selection cursor 1505 (a sight) is displayed on the display apparatus 108 and the display position of the rendering data is modified using the operating device 1503 (a touch pad).

Note that in contrast to the selection cursor 1415 of FIG. 15A, the selection cursor 1505 (the sight) has a fixed display position. Further, the operating device 1504 is capable of multi-gesture input. As an example of multi-gesture input, an operation in which the operating device is touched by a single finger and the finger is moved while remaining in touch with the operating device is known as a single finger scroll. In this embodiment, a single finger scroll is allocated to a display position modification instruction. An operation in which the operating device is touched by two fingers and an interval between the two fingers is widened while keeping the fingers in touch with the operating device is known as a pinch-out. In this embodiment, a pinch-out is allocated to a display enlargement instruction. An operation in which the operating device is touched by two fingers and the interval between the two fingers is narrowed while keeping the fingers in touch with the operating device is known as a pinch-in. In this embodiment, a pinch-in is allocated to a display reduction instruction. For example, when the single finger scroll operation is performed in a condition where the rendering data for the partial image of the sample are displayed on one display apparatus 108, it is determined that a display position modification instruction has been issued, and accordingly, the display position of the partial image of the sample is modified (scrolled). In this example, the display position of the partial image of the sample is modified, but the present invention is not limited thereto. Further, when the user performs the pinch-out operation in a condition where the rendering data (the fifth image data) for displaying the plurality of slide images (the thumbnail image list) are displayed on the display apparatus 108, it is determined that the slide displayed in the position of the selection cursor 1505 (i.e. the zoom-in operation) has been selected. Accordingly, the rendering data are switched to the rendering data (the second image data) for displaying the full image of the slide. Furthermore, when the user performs the pinch-in operation in a condition where the rendering data for displaying a partial image of the sample are displayed at the 20 times display magnification on the display apparatus 108, it is determined that an instruction to switch the display magnification to 10 times about the selection cursor 1505 (i.e. to perform the zoom-out operation) has been issued, and therefore the display magnification is modified to 10 times. As a result, the display is switched to the rendering data (the fourth image data) for displaying the partial image or the sample at the 10 times display magnification about the selection cursor 1505.

Hence, when the user performs the zoom-in operation or the zoom-out operation, the rendering data can be switched in accordance with the position of the selection cursor (the sight). In this embodiment, an example in which the rendering data for displaying the plurality of slide images (the thumbnail image list) and the partial image of the sample are displayed was described, but the present invention is not limited thereto. Moreover, the form of the selection cursor (the sight) displayed on the display apparatus 108 is not limited to that in this embodiment. Further, an example in which the selection cursor (the sight) and the rendering data are displayed on the display apparatus 108 was described, but the selection cursor (the sight) end the rendering data may be displayed on the operating device 1503. A pinch-out and a pinch-in are performed on the operating device 1503 as the zoom-in operation and the zoom-out operation, but the zoom-in operation and the zoom-out operation are not limited thereto. Furthermore, in the above description, the selection cursor either moves over the screen (in the form of an arrow), as in the selection cursor having the reference numeral 1415, or is fixed on the screen (in the form of a sight), as in the selection cursor having the reference numeral 1505, but the selection cursor may be displayed as a combination thereof.

According to this embodiment, as described above, an observer is not required to perform operations to switch to another application, activate another application, view other physical silver halide photographs or the like, observer an actual object, and so on. By means of a simple operation (the zoom-in operation and the zoom-out operation), the display can be switched consecutively between clinical information such as the patient list (an order), the clinical image, the full image of the gross sample, the partial image of the gross sample, the plurality of slide images (the thumbnail image list), and the full image of the slide, and pathological information such as the full image of the sample, the partial image of the sample, the partial image of the sample at the maximum display magnification, and the electron microscope image. As a result, the observer is less likely to lose sight of the area of interest, and therefore an observation (diagnosis) operation can be performed efficiently. Further, by connecting the clinical information and the pathological information consistently, it is possible to confirm from the image whether or not the patient and the gross sample match, whether or not the sample matches the extraction position of the gross sample during the operation, and so on, and therefore mistakes in which the patient and the gross sample/the sample are mixed up can be reduced. Moreover, a pathological diagnosis result obtained by observing the sample image (a cell or tissue structure and the spread of a pathological abnormality) can be associated in a sensory fashion with the information relating to the plurality of slide images (the thumbnail image list), the partial image of the gross sample, and the full image of the gross sample. According to this embodiment, even when the image is switched by performing a zoom-in/zoom-out operation, the display position of a focus position on the tissue or cell does not shift, and therefore an operation to make associations between different images, which is performed in the mind conventionally, can be facilitated. As a result, the three-dimensional structure of the tissue or cell constituting the organ can be grasped. Further, the size and degree of advancement of the pathological abnormality, such as the locations of the gross sample to which the pathological abnormality has spread, can be grasped. Furthermore, during display of the partial image of the sample at the maximum display magnification, it is possible to switch to the electron microscope image and to switch the depth position, and therefore detailed information relating to the structure within the nucleus can be grasped by means of a simple operation. Moreover, the range in which an operation was performed, and the required range of and reasons for the operation (whether or not the site of the pathological abnormality was completely removed by the operation and so on) can be explained to a patient carefully and in order from a molecular level to an organ level, while structural relationships and connections between the molecular level, the cellular level, the tissue level, and the organ level can be described easily and in sequence to large numbers of students and participants at conferences and the like. Furthermore, the respective rendering data can be displayed and switched in full screen even on the display area of a screen of a portable terminal having a small display area, such as a tablet or the like, leading to improvements in visibility and operability. As a result, image switching and observation (diagnosis) can be performed easily and consistently by means of a minimal amount of simple operations in relation to patient information, detailed cell and tissue information, and even molecular information.

### Other Embodiments

The object of the present invention may be achieved as follows. A non-transitory recording medium (or a storage medium) recorded with program code of software for realizing all or a part of the functions of the embodiments described above is supplied to a system or an apparatus. A computer (or a CP0 or an MPU) of the system or the apparatus then reads and executes the program code stored on the recording medium. In this case, the program code read from the recording medium realizes the functions of the above embodiments, and therefore the non-transitory recording medium recorded with the program code constitutes the present invention.

Further, when the computer executes the read program code, an operating system (OS) or the like that operates on the computer performs all or a part of the actual processing on the basis of instructions included in the program code. A case in which the functions of the above embodiments are realized by this processing may also be included in the present invention.

Furthermore, the program code read from the recording medium may be written to a memory provided in a function expansion card inserted into the computer or a function expansion unit connected to the computer. A CPU or the like provided in the function expansion card or function expansion unit then performs all or a part of the actual processing on the basis of the instructions included in the program code, and a case in which the functions of the above embodiments are realized by this processing may also be included in the present invention.

When the present invention is applied to the recording medium described above, program code corresponding to the flowcharts described above is stored on the recording medium.

A case in which the functions of the above embodiments are realized by having the CPU 200 execute a program was described above, but the present invention is not limited thereto. For example, a part or all of the functions may be realized by hardware.

Further, the present invention is not limited to implementation by the image processing apparatus 107 to which the display apparatus 108 is connected, and the rendering data may be generated by another image processing apparatus connected to a network. In this case, rendering data transmitted via the network may be displayed on the display apparatus 108. In other words, the present invention may also be applied to a system configuration in which rendering data generation and image display are performed in different positions.

Furthermore, the configurations described in the first to fourth embodiments may be combined with each other.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-016512, filed on Jan. 30, 2012, and Japanese Patent Application No. 2012-262391, filed on Nov. 30, 2012, which are hereby incorporated by reference herein in their entirety.

### REFERENCE SIGNS

107: Image Processing Apparatus

400: Operation Instruction Input Terminal

401: Image Data Input Terminal

402: Display Mode Switching Control Unit

403: Rendering Data Generation Unit

404: Rendering Data Output Unit

1. An image processing apparatus capable of displaying, on a display apparatus, first image data for displaying a full image of a sample and second image data for displaying a full image of a slide glass on which the sample is provided,
the image processing apparatus comprising a modification unit that modifies the image data displayed on the display apparatus on the basis of a user operation,
wherein, when a user performs a zoom-out operation to reduce a displayed image in a condition where the first image data are displayed on the display apparatus, the modification unit displays the second image data on the display apparatus.

2. The image processing apparatus according to claim 1, wherein when the user performs a zoom-in operation to enlarge a displayed image in a condition where the second image data are displayed on the display apparatus, the modification unit displays the first image data on the display apparatus.

3. The image processing apparatus according to claim 1, wherein the image processing apparatus is capable of displaying fifth image data for displaying a full image of a plurality of slides on the display apparatus, and
when the user performs a zoom-out operation to reduce a displayed image in a condition where the second image data are displayed on the display apparatus, the modification unit displays the fifth image data on the display apparatus.

4. The image processing apparatus according to claim 1, wherein the image processing apparatus is capable of displaying fifth image data for displaying a full image of a plurality of slides on the display apparatus, and
when the user performs a zoom-in operation to enlarge a displayed image in a condition where the fifth image data are displayed on the display apparatus, the modification unit displays the second image data on the display apparatus.

5. The image processing apparatus according to claim 3, wherein the sample is a part of a gross sample,
the image processing apparatus is capable of displaying, on the display apparatus, third image data for displaying a full image of the gross sample or sixth image data for displaying a partial image of the gross sample, and
when the user performs a zoom-out operation to reduce a displayed image in a condition where the fifth image data are displayed on the display apparatus, the modification unit displays the third image data or the sixth image data on the display apparatus.

6. The image processing apparatus according to claim 3, wherein the sample is a part of a gross sample,
the image processing apparatus is capable of displaying, on the display apparatus, third image data for displaying a full image of the gross sample or sixth image data for displaying a partial image of the gross sample, and
when the user performs a zoom-in operation to enlarge a displayed image in a condition where the third image data or the sixth image data are displayed on the display apparatus, the modification unit displays the fifth image data on the display apparatus.

7. The image processing apparatus according to claim 1, wherein the sample is a part of a gross sample,
the image processing apparatus is capable of displaying, on the display apparatus, third image data for displaying a full image of the gross sample and sixth image data for displaying a partial image of the gross sample, and
when the user performs a zoom-out operation to reduce a displayed image in a condition where the sixth image data are displayed, the modification unit displays the third image data on the display apparatus.

8. The image processing apparatus according to claim 1, wherein the sample is a part of a gross sample,
the image processing apparatus is capable of displaying, on the display apparatus, third image data for displaying a full image of the gross sample and sixth image data for displaying a partial image of the gross sample, and
when the user performs a zoom-in operation to enlarge a displayed image in a condition where the third image data are displayed, the modification unit displays the sixth image data on the display apparatus.

9. The image processing apparatus according to claim 5, wherein the image processing apparatus is capable of displaying eighth image data for displaying a clinical image on the display apparatus, and
when the user performs a zoom-out operation to reduce a displayed image in a condition where the third image data are displayed, the modification unit displays the eighth image data on the display apparatus.

10. The image processing apparatus according to claim 5, wherein the image processing apparatus is capable of displaying eighth image data for displaying a clinical image on the display apparatus, and
when the user performs a zoom-in operation to enlarge a displayed image in a condition where the eighth image data are displayed, the modification unit displays the third image data on the display apparatus.

11. The image processing apparatus according to claim 9, wherein the image processing apparatus is capable of displaying ninth image data for displaying a patient list on the display apparatus, and
when the user performs a zoom-out operation to reduce a displayed image in a condition where the eighth image data are displayed, the modification unit displays the ninth image data on the display apparatus.

12. The image processing apparatus according to claim 9, wherein the image processing apparatus is capable of displaying ninth image data for displaying a patient list on the display apparatus, and
when the user performs a zoom-in operation to enlarge a displayed image in a condition where the ninth image data are displayed, the modification unit displays the eighth image data on the display apparatus.

13. The image processing apparatus according to claim 1, wherein the sample is a part of a gross sample,
the image processing apparatus is capable of displaying, on the display apparatus, third image data for displaying a full image of the gross sample or sixth image data for displaying a partial image of the gross sample, and
when the user performs a zoom-out operation to reduce a displayed image in a condition where the second image data are displayed on the display apparatus, the modification unit displays the third image data or the sixth image data on the display apparatus.

14. The image processing apparatus according to claim 1, wherein the image processing apparatus is capable of displaying fourth image data for displaying a partial image of the sample on the display apparatus,
when the user performs a zoom-in operation to enlarge a displayed image in a condition where the first image data are displayed on the display apparatus, the modification unit displays the fourth image data on the display apparatus, and
when the user performs a zoom-out operation to reduce a displayed image in a condition where the fourth image data are displayed on the display apparatus, the modification unit displays the first image data on the display apparatus.

15. The image processing apparatus according to claim 14, wherein when the user performs a zoom-out operation to reduce a displayed image in a condition where the fourth image data are displayed on the display apparatus, the modification unit displays the first image data on the display apparatus by modifying a display position, which is a position in which the sample is displayed on the display apparatus, without modifying a display magnification.

16. The image processing apparatus according to claim 14, wherein the image processing apparatus is capable of displaying seventh image data for displaying a partial image of the sample on the display apparatus,
the seventh image data are image data obtained by a different imaging apparatus from the fourth image data, and
when the user performs a zoom-in operation to enlarge a displayed image in a condition where the fourth image data are displayed on the display apparatus, the modification unit displays the seventh image data on the display apparatus.

17. The image processing apparatus according to claim 14, wherein the image processing apparatus is capable of displaying seventh image data for displaying a partial image of the sample on the display apparatus,
the seventh image data are image data obtained by a different imaging apparatus from the fourth image data, and
when the user performs a zoom-out operation to reduce a displayed image in a condition where the seventh image data are displayed on the display apparatus, the modification unit displays the fourth image data on the display apparatus.

18-22. (canceled)

23. The image processing apparatus according to claim 1, wherein the second image data are image data for displaying a full image of the slide glass on which the sample is provided, and a frame representing a size of the sample.

24. The image processing apparatus according to claim 1, wherein the first image data are image data for displaying a full image of the sample and a full image of the slide glass on which the sample is provided.

25. The image processing apparatus according to claim 5, wherein the third image data are image data for displaying a full image of the gross sample and a full image of the slide glass on which the sample is provided.

26. The image processing apparatus according to claim 1, wherein the second image data are image data obtained by a different imaging apparatus from the first image data.

27. An image processing method in which first image data for displaying a full image of a sample and second image data for displaying a full image of a slide glass on which the sample is provided can be displayed on a display apparatus,
the image processing method comprising a modification step in which a computer modifies the image data displayed on the display apparatus on the basis of a user operation,
wherein the modification step includes a step in which, when a user performs a zoom-out operation to reduce a displayed image in a condition where the first image data are displayed on the display apparatus, the computer displays the second image data on the display apparatus.

28-32. (canceled)

33. A non-transitory computer readable storage medium storing a program for causing a computer to execute each step of the image processing method according to claim 27.

34. (canceled)

35. The image processing apparatus according to claim 1, wherein, when a user performs the zoom-out operation in a condition where the first image data, whose display magnification is a lower limit value, are displayed on the display apparatus, the modification unit displays the second image data on the display apparatus.

36. The image processing apparatus according to claim 2, wherein when the user performs the zoom-out operation in a condition where the second image data are displayed on the display apparatus, the modification unit displays the first image data, whose display magnification is a lower limit, on the display apparatus.
